(19) United States
(12) Patent Application Publication
(10) Pub. No.: US 2025/0147377 A1
(43) Pub. Date: May 8, 2025

(54) OPTICAL MODULATOR ELEMENT, OPTICAL TRANSMITTER, AND OPTICAL TRANSCEIVER

(71) Applicant: FUJITSU OPTICAL COMPONENTS LIMITED, Kawasaki-shi (JP)

(72) Inventors: NOBUAKI MITAMURA, Saitama (JP); Kazumasa SATO, Chigasaki (JP)

(73) Assignee: FUJITSU OPTICAL COMPONENTS LIMITED, Kawasaki-shi (JP)

(21) Appl. No.: 18/905,790

(22) Filed: Oct. 3, 2024

(30) Foreign Application Priority Data
Nov. 2, 2023 (JP) 2023-188910

(51) Int. Cl. G02F 1/21; G02F 1/01; G02F 1/225; H04B 10/516

(52) U.S. Cl. CPC G02F 1/212; G02F 1/0147; G02F 1/225; H04B 10/516; G02F 2202/20

(57) ABSTRACT

An optical modulator element includes, on a substrate, an optical branching portion and an optical multiplexing portion each of which includes a first material, two optical waveguide arms each of which connects the optical branching portion and the optical multiplexing portion, and electrodes that apply an electrical signal to the two optical waveguide arms waveguide. Each optical waveguides of the two optical waveguide arms includes a first optical waveguide that includes the first material, a second optical waveguide that includes a second material that has a higher electro-optical effect than the first material, and a transition portion that performs an optical transition between the first optical waveguide and the second optical waveguide. The substrate includes a hollow portion in which all or a part of the substrate located below the second optical waveguide in a plan view has been removed.

### CROSS-REFERENCE TO RELATED APPLICATION

This application is based upon and claims the benefit of priority of the prior Japanese Patent Application No. 2023-188910, filed on Nov. 2, 2023, the entire contents of which are incorporated herein by reference.

### FIELD

The embodiments discussed herein are related to an optical modulator element, an optical transmitter, and an optical transceiver.

### BACKGROUND

For example, there is a demand for larger capacity of an optical network due to a rapid increase in amount of communication traffic of Internet protocol (IP) data. In addition, in order to spatially increase accommodation efficiency of an inner part of an optical transceiver, further reduction in size and integration of an optical transmitter/receiver is desired. A silicon (Si) waveguide used for the optical transmitter/receiver strongly confines light, so that a bend radius can be reduced to about 10 μm. Accordingly, a SiPh (silicon photonics) element is starting to be applied to an optical transmitter or an optical receiver operating at a baud rate of 64G.

An optical device is also referred to as a Si Photonics element (hereinafter, referred to as a SiPh element) because an optical circuit is constituted by a Si waveguide that is manufactured by using a Silicon-On-Insulator (SOI) wafer. An optical modulator element and an optical receiver element that are included in the optical device are connected by an optical waveguide. The SiPh element is able to be manufactured such that, by utilizing a process technology of a Si electrical semiconductor element and a process facility, a large number of elements are able to be manufactured at a time by using, for example, a Si wafer with diameters ranging from 8 inches to 12 inches. Furthermore, in the SiPh element, light is strongly confined due to large refractive index of Si of about 3.4, and thus the bend radius of the Si optical waveguide is able to be reduced to about 10 μm. Consequently, it is possible to reduce the size of the element. Therefore, an advantage is provided in that economies of scale are high and a cost is low.
Patent Document 1: Japanese Laid-open Patent Publication No. 2003-270599
Patent Document 2: Japanese Laid-open Patent Publication No. 2015-191031
Patent Document 3: U.S. Patent Application Publication No. 2020/0152574

However, in Si modulators, such as an X polarization modulation unit and a Y polarization modulation unit included in the optical modulator element provided in a conventional optical device, a voltage is applied by way of a Si layer doped with impurities instead of directly applying a voltage to a waveguide by using metal electrodes, so that an electrical resistance is higher as compared in a case where only the metal electrodes are used. In addition, the capacity of the optical waveguide that is used in the Si modulator is large due to a p-n junction structure. As a result, a high frequency loss increases. Therefore, under the assumption that a driver is driven at a practical driving voltage (equal to or less than ±2 V or 4 V), it is difficult to broaden the bandwidth equal to or greater than 50 GHZ and speed up the baud rate equal to or greater than 96 G.

Accordingly, many reports of an attempt to integrate electro-optical materials, such as LiNbO₃ (hereinafter, simply referred to as a LN), having an electro-optical effect capable of speeding up the baud rate equal to or greater than 96 G on the SiPh element have been made at academic conferences or the like. (for example, Mingbo Hel et. al. “High-performance hybrid silicon and lithium niobate Mach-Zehnder modulators for 100 Gbit s⁻¹ and beyond”, Nat. Photon. 13, 359-364 (2019))

However, the electric permittivity of Si used for a substrate of the SiPh element is about 12, which is relatively large, so that the refractive index of an electrical signal with high frequency travelling through electrodes tends to increase. In particular, as an electrode structure of the modulator, in a case where capacity-loaded electrodes that are advantageous for a reduction in high frequency loss due to an increase in available electrode size as a result of a broad distribution of electric current is used, the refractive index of the electrical signal is also increased caused by an influence of the capacity-loaded electrodes, in addition to the influence of the substrate refractive index. Consequently, when compared with a velocity of signal light propagating through a LN waveguide, the velocity of the electrical signal becomes slightly low, and bandwidth limitation occurs due to a mismatch of velocity matching. Therefore, it is difficult to implement wider bandwidth equal to or greater than 100 GHz needed for the baud rate of 200 G.

### SUMMARY

According to an aspect of an embodiment, an optical modulator element includes an optical branching portion, an optical multiplexing portion, two optical waveguide arms and electrodes. Each of the optical branching portion and the optical multiplexing portion includes a first material and is formed on a substrate. Each of two optical waveguide arms connects the optical branching portion and the optical multiplexing portion and is formed on the substrate. The electrodes apply an electrical signal to the two optical waveguide arms and are formed on the substrate. Each of optical waveguides of the two optical waveguide arms includes a first optical waveguide, a second optical waveguide and a transition portion. The first optical waveguide includes the first material. The second optical waveguide includes a second material that has a higher electro-optical effect than the first material. The transition portion performs an optical transition between the first optical waveguide and the second optical waveguide. The substrate includes a hollow portion in which all or a part of the substrate located below the second optical waveguide in a plan view has been removed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan diagram illustrating one example of an optical transmitter/receiver according to the present embodiment;

FIG. 2 is a schematic plan diagram illustrating one example of a child MZM according to a first embodiment;

FIG. 3 is an explanation diagram illustrating one example of a first transition portion included in the child MZM;

FIG. 4 is a cross-sectional schematic diagram illustrating one example of a cross section taken along line A-A illustrated in FIG. 3;

FIG. 5 is a cross-sectional schematic diagram illustrating one example of a cross section taken along line B-B illustrated in FIG. 3;

FIG. 6 is a cross-sectional schematic diagram illustrating one example of a cross section taken along line C-C illustrated in FIG. 3;

FIG. 7 is a schematic plan diagram illustrating one example of capacity loading type electrodes included in the child MZM;

FIG. 8 is a cross-sectional schematic diagram illustrating one example of a cross section taken along line A-A illustrated in FIG. 2;

FIG. 9 is a cross-sectional schematic diagram illustrating one example of a cross section taken along line B-B illustrated in FIG. 2;

FIG. 10 is a cross-sectional schematic diagram illustrating one example of a cross section taken along line C-C illustrated in FIG. 2;

FIG. 11 is an explanation diagram illustrating one example of a relationship between a substrate removal width and a high frequency refractive index exhibited in the child MZM;

FIG. 12 is an explanation diagram illustrating one example of frequency dependence of an EO characteristic exhibited in the child MZM;

FIG. 13 is a cross-sectional schematic diagram illustrating one example of a child MZM according to a second embodiment;

FIG. 14 is a cross-sectional schematic diagram illustrating one example of the child MZM according to the second embodiment;

FIG. 15 is an explanation diagram illustrating one example of a relationship between a substrate removal width and a high frequency refractive index exhibited in the child MZM;

FIG. 16 is an explanation diagram illustrating one example of a relationship between a substrate removal rate for each substrate removal width and a high frequency refractive index;

FIG. 17 is an explanation diagram illustrating one example of frequency dependence of an EO characteristic for each substrate removal rate exhibited in the child MZM;

FIG. 18 is a schematic plan diagram illustrating one example of a child MZM according to a third embodiment;

FIG. 19 is a cross-sectional schematic diagram illustrating one example of a cross section taken along line A-A illustrated in FIG. 18;

FIG. 20 is a cross-sectional schematic diagram illustrating one example of a cross section taken along line B-B illustrated in FIG. 18;

FIG. 21 is a cross-sectional schematic diagram illustrating one example of a cross section taken along line C-C illustrated in FIG. 18;

FIG. 22 is a cross-sectional schematic diagram illustrating one example of a child MZM according to a fourth embodiment;

FIG. 23 is a cross-sectional schematic diagram illustrating one example of the child MZM according to the fourth embodiment;

FIG. 24 is a cross-sectional schematic diagram illustrating one example of a child MZM according to a fifth embodiment;

FIG. 25 is a cross-sectional schematic diagram illustrating one example of the child MZM according to the fifth embodiment;

FIG. 26 is a schematic plan diagram illustrating one example of a modulator according to a sixth embodiment;

FIG. 27 is a schematic plan diagram illustrating one example of a child MZM according to a seventh embodiment;

FIG. 28 is a cross-sectional schematic diagram illustrating one example of a cross section taken along line A-A illustrated in FIG. 27;

FIG. 29 is a cross-sectional schematic diagram illustrating one example of a cross section taken along line B-B illustrated in FIG. 27;

FIG. 30 is a schematic plan diagram illustrating one example of a modulator according to an eighth embodiment; and

FIG. 31 is a block diagram illustrating one example of an optical transceiver according to the present embodiment.

### DESCRIPTION OF EMBODIMENTS

Preferred embodiments of the present invention will be explained with reference to accompanying drawings. Furthermore, the present invention is not limited to the embodiments. In addition, each of the embodiments may be used in any appropriate combination as long as they do not conflict with each other.

### (a) First Embodiment

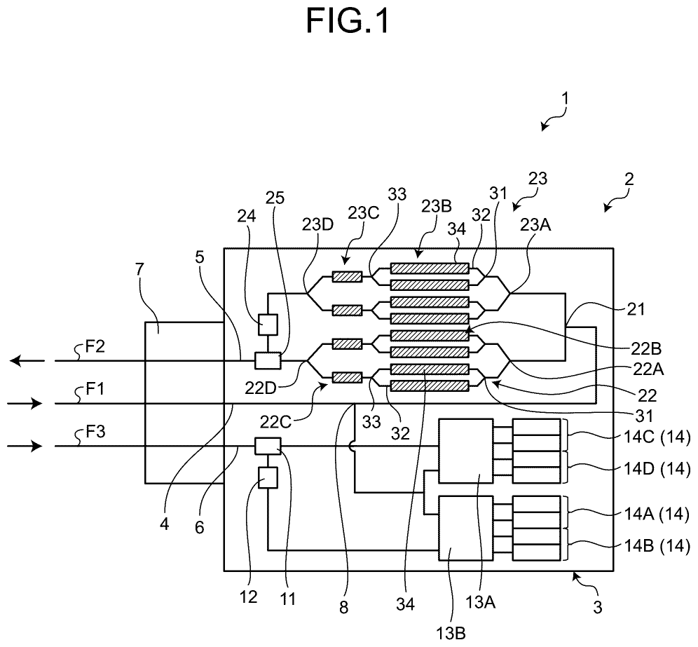

FIG. 1 is a schematic plan diagram illustrating one example of an optical transmitter/receiver 1 according to the present embodiment. The optical transmitter/receiver 1 illustrated in FIG. 1 is an optical device with a type of Dual Polarization-Quadrature Phase Shift Keying (DP-QPSK) with baud rate of, for example, 200 G. The optical transmitter/receiver 1 includes an optical modulator element 2 and an optical receiver element 3. Each of the optical modulator element 2 and the optical receiver element 3 is constituted by, for example, a SiPh element. The optical transmitter/receiver 1 includes a local oscillator purpose optical waveguide 4, a transmission purpose optical waveguide 5, a reception purpose optical waveguide 6, a glass block 7, and a third branching portion 8.

The local oscillator purpose optical waveguide 4 is, for example, a Si waveguide that is optically connected to a local oscillator purpose optical fiber F1 by way of the glass block 7 by using a butt joint bonding technique, and that propagates local oscillator light. The transmission purpose optical waveguide 5 is, for example, a Si waveguide that is optically connected to an output side optical fiber F2 by way of the glass block 7 by using a butt joint bonding technique, and that propagates transmitted light. The reception purpose optical waveguide 6 is, for example, a Si waveguide that is optically connected to an input side optical fiber F3 by way of the glass block 7 by using a butt joint bonding technique, and that propagates received light. The local oscillator light that is incident from the local oscillator purpose optical waveguide 4 is branched into two at the third branching portion 8, one of the branched local oscillator light is used as a light source of the optical modulator element 2, and the other of the branched local oscillator light is used as local oscillator light of the optical receiver element 3. A branching ratio of the third branching portion 8 is optimally adjusted in accordance with an application.

The optical receiver element 3 includes a polarization beam splitter (PBS) 11 and a first polarization rotator (PR) 12. The optical receiver element 3 includes a first optical hybrid circuit 13A, a second optical hybrid circuit 13B, and a first to a fourth photo diode (PD) sets 14A to 14D (14).

The PBS 11 splits the received light that has been input from the reception purpose optical waveguide 6 into two orthogonal polarization state, that is, for example, an X polarization component and a Y polarization component. Furthermore, the X polarization component is a horizontal polarization component, whereas the Y polarization component is a vertical polarization component. The PBS 11 outputs the split X polarization component to the first optical hybrid circuit 13A. Moreover, the first PR12 performs polarization rotation on the Y polarization component received from the PBS 11 by 90 degrees, and outputs the Y polarization component that has been subjected to the polarization rotation to the second optical hybrid circuit 13B.

The first optical hybrid circuit 13A acquires an optical signal having an I component and a Q component by allowing the local oscillator light to interfere with the X polarization component included in the received light. Furthermore, the I component is an in-phase axis component, whereas the Q component is a quadrature axis component. The first optical hybrid circuit 13A outputs the signal light having the I component included in the X polarization component to the first PD set 14A. The first optical hybrid circuit 13A outputs the signal light having the Q component included in the X polarization component to the second PD set 14B.

The second optical hybrid circuit 13B acquires signal light having the I component and the Q component by allowing the local oscillator light to interfere with the Y polarization component that has been subjected to the polarization rotation. The second optical hybrid circuit 13B outputs the signal light having the I component included in the Y polarization component to the third PD set 14C. The second optical hybrid circuit 13B outputs the signal light having the Q component included in the Y polarization component to the fourth PD set 14D.

The first PD set 14A outputs an electrical signal by performing electrical conversion on the signal light with the I component included in the X polarization component received from the first optical hybrid circuit 13A. The second PD set 14B outputs an electrical signal by performing electrical conversion on the signal light with the Q component included in the X polarization component received from the first optical hybrid circuit 13A.

The third PD set 14C outputs an electrical signal by performing electrical conversion on the signal light with the I component included in the Y polarization component received from the second optical hybrid circuit 13B. The fourth PD set 14D outputs an electrical signal by performing electrical conversion on the signal light with the Q component included in the Y polarization component received from the second optical hybrid circuit 13B.

The optical modulator element 2 includes a first branching portion 21, an X polarization modulation unit 22, a Y polarization modulation unit 23, a second PR 24, and a polarization beam combiner (PBC) 25. The first branching portion 21 branches and outputs the local oscillator light to the X polarization modulation unit 22 and the Y polarization modulation unit 23.

The X polarization modulation unit 22, that is, a parent MZM provided on the X polarization side, includes a second branching portion 22A, two child Mach-Zehnder modulators (MZMs) 22B, two parent DC phase shifters 22C, and a first multiplexing portion 22D. The second branching portion 22A branches and outputs the signal light received from the first branching portion 21 to each of the child MZMs 22B. Each of the child MZMs 22B includes a branching portion 31, two optical waveguide arms 32, a multiplexing portion 33, and an RF electrode 34.

The branching portion 31 included in the X polarization modulation unit 22 outputs the signal light received from the second branching portion 22A to the two optical waveguide arms 32. The multiplexing portion 33 multiplexes the pieces of signal light propagating the two optical waveguide arms 32, and outputs the multiplexed signal light to the parent DC phase shifter 22C. One of the child MZMs 22B included in the X polarization modulation unit 22 is, for example, a modulation unit that modulates, in accordance with a high frequency signal output from the RF electrode 34, the signal light having the I component included in the X polarization propagating through the two optical waveguide arms 32, and that outputs the modulated signal light having the I component to the parent DC phase shifter 22C. Furthermore, the other of the child MZMs 22B included in the X polarization modulation unit 22 is, for example, a modulation unit that modulates, in accordance with the high frequency signal output from the RF electrode 34, the signal light having the Q component included in the X polarization propagating through the two optical waveguide arms 32, and that outputs the modulated signal light having the Q component to the parent DC phase shifter 22C.

Each of the parent DC phase shifters 22C included in the X polarization modulation unit 22 is a phase adjustment unit that adjusts, in accordance with a driving voltage signal, the phase of the modulated signal light that has the I component included in the X polarization and that has been received from one of the child MZMs 22B, and adjusts, in accordance with a driving voltage signal, the phase of the modulated signal light that has the Q component included in the X polarization and that has been received from the other of the child MZMs 22B. As a result of the phase adjustment performed by each of the parent DC phase shifters 22C, it is possible to orthogonalize the modulated signal light having the I component included in the X polarization and the modulated signal light having the Q component included in the X polarization. Both of the signal light having the I component included in the X polarization and the signal light having the Q component included in the X polarization that have passed through the parent DC phase shifter 22C are multiplexed in the first multiplexing portion 22D, and the multiplexed IQ mixed signal included in the X polarization is output to the PBC 25.

The Y polarization modulation unit 23, that is, the parent MZM on the Y polarization, includes a second branching portion 23A, two child MZMs 23B, two parent DC phase shifters 23C, and a first multiplexing portion 23D. The second branching portion 23A branches and outputs the signal light received from the first branching portion 21 to each of the child MZMs 23B. Each of the child MZMs 23B includes the branching portion 31, the two optical waveguide arms 32, the multiplexing portion 33, and the RF electrode 34.

The branching portion 31 included in the Y polarization modulation unit 23 outputs the signal light received from the second branching portion 23A to each of the two optical waveguide arms 32. The multiplexing portion 33 multiplexes the signal light propagating through each of the two optical waveguide arms 32, and outputs the multiplexed signal light to the parent DC phase shifter 23C. One of the child MZMs 23B included in the Y polarization modulation unit 23 is, for example, a phase modulation unit that modulates, in accordance with a high frequency signal output from the RF electrode 34, the signal light having the I component included in the Y polarization propagating through the two optical waveguide arms 32, and that outputs the modulated signal light having the I component to the parent DC phase shifter 23C. Furthermore, the other of the child MZMs 23B included in the Y polarization modulation unit 23 is, for example, a phase modulation unit that modulates, in accordance with a high frequency signal output from the RF electrode 34, the signal light having the @ component included in the Y polarization propagating through the two optical waveguide arms 32, and that outputs the modulated signal light having the Q component to the parent DC phase shifter 23C.

Each of the parent DC phase shifters 23C included in the Y polarization modulation unit 23 is a phase adjustment unit that adjusts, in accordance with a driving voltage signal, the phase of the modulated signal light that has the I component included in the Y polarization and that has been received from the one child MZM 23B, and adjusts the phase of the modulated signal light that has the Q component included in the Y polarization and that has been received from the other child MZM 23B. As a result of the phase adjustment performed by the parent DC phase shifter 23C, it is possible to orthogonalize the modulated signal light having the I component included in the Y polarization and the modulated signal light having the Q component included in the Y polarization. Both of the signal light having the I component included in the Y polarization and the signal light having the Q component included in the Y polarization that have passed through the parent DC phase shifter 23C are multiplexed in the first multiplexing portion 23D, and the multiplexed IQ mixed signal with Y polarization is output to the second PR 24.

The second PR 24 performs polarization rotation on the IQ mixed signal with Y polarization by 90 degrees, and outputs the IQ mixed signal with Y polarization that has been subjected to the polarization rotation to the PBC 25. Then, the PBC 25 multiplexes both of the IQ mixed signal with X polarization received from the X polarization modulation unit 22 and the IQ mixed signal with Y polarization that has been subjected to polarization rotation and that has been received from the second PR 24, and then, outputs the multiplexed IQ mixed signal from the transmission purpose optical waveguide 5.

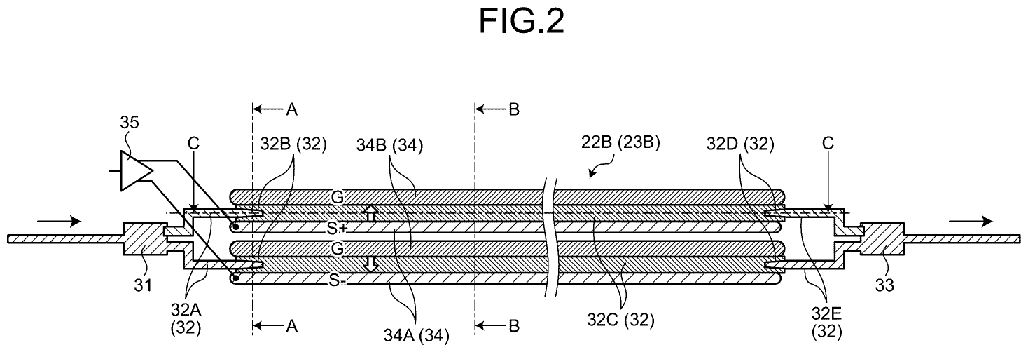

FIG. 2 is a schematic plan diagram illustrating one example of the child MZM 22B (23B) according to the first embodiment. One of the child MZMs 22B included in the X polarization modulation unit 22 will be described. Furthermore, each the child MZMs 23B included in the Y polarization modulation unit 23 also has the same configuration as that of each of the child MZMs 22B included in the X polarization modulation unit 22; therefore, by assigning the same reference numerals to components having the same configuration thereof, overlapped descriptions of the configuration and the operation thereof will be omitted.

Each of the child MZM 22B (23B) includes, as described above, the branching portion 31, the two optical waveguide arms 32, the multiplexing portion 33, and the RF electrode 34. The branching portion 31 is, for example, a branching portion that is made of Si and that branches and outputs the signal light received from the second branching portion 22A (23A) to each of first Si waveguides 32A that are included in the two optical waveguide arms 32. The two optical waveguide arms 32 are two arms each of which includes the two first Si waveguides 32A, two first transition portions 32B, two LN waveguides 32C, two second transition portions 32D, and two second Si waveguides 32E. Each of the first Si waveguides 32A is, for example, a Si waveguide with a channel type. Each of the first Si waveguides 32A is a tapered waveguide in which one end of the waveguide width is formed to have a tapered shape. Each of the LN waveguides 32C is, for example, a LN waveguide with a ridge type. Each of the second Si waveguides 32E is, for example, a Si waveguide with a channel type. Each of the second Si waveguides 32E is a tapered waveguide in which one end of the waveguide width is formed to have a tapered shape. The first Si waveguides 32A and the second Si waveguides 32E are formed in the same layer, whereas the LN waveguides 32C are formed in a layer that is different from the layer in which the first Si waveguides 32A and the second Si waveguides 32E are formed.

Each of the first transition portions 32B is an interlayer transition portion in which the signal light is optically transitioned between the first Si waveguide 32A and the LN waveguide 32C in the respective layers. Furthermore, the first Si waveguides 32A and the LN waveguides 32C are disposed in different layers. The RF electrode 34 includes signal electrodes 34A that are arranged in parallel to the respective waveguides included the two respective optical waveguide arms 32, and ground electrodes 34B that are arranged in parallel to the respective waveguides. In a case where a high frequency signal received from a driver circuit 35 is input, each of the signal electrodes 34A modulates the signal light propagating through the LN waveguide 32C that is arranged between the ground electrode 34B and the signal electrode 34A.

Each of the second transition portions 32D is an interlayer transition portion in which the modulated signal light is optically transitioned between the LN waveguide 32C and the second Si waveguide 32E in the respective layers. Furthermore, the second Si waveguides 32E and the LN waveguides 32C are disposed in different layers. The multiplexing portion 33 is, for example, a multiplexing portion that is made of Si, that multiplexes the modulated signal light received from each of the second Si waveguides 32E, and that outputs the multiplexed signal light to each of the parent DC phase shifters 22C (23C).

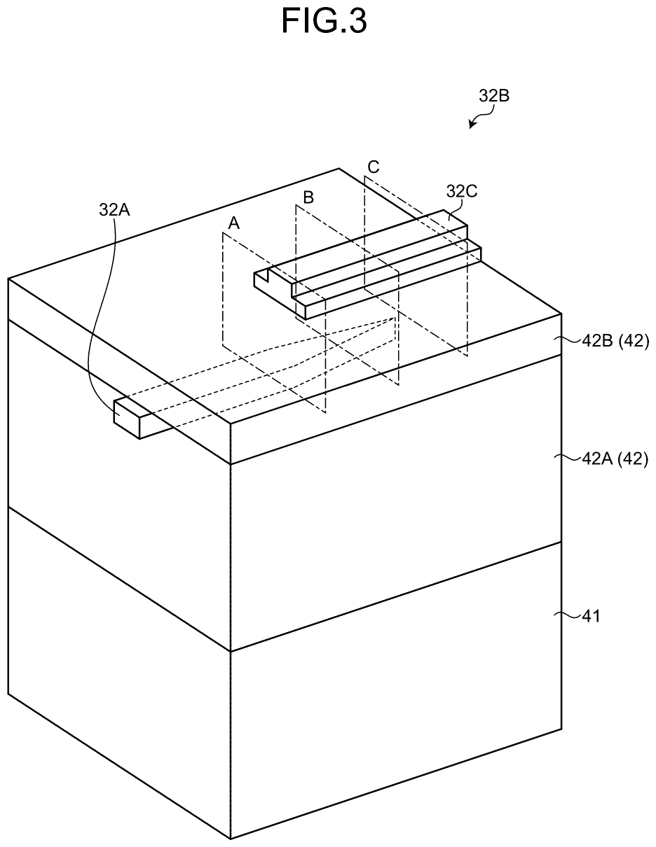

FIG. 3 is an explanation diagram illustrating one example of the first transition portion 32B included in the child MZM 22B. The first transition portion 32B includes a Si substrate 41, and a clad layer 42 that is formed on the Si substrate 41. The clad layer 42 is a SiO₂ layer that has the refractive index lower than that of the Si substrate 41 and that has a thickness of, for example, 4 μm. The clad layer 42 includes a first clad layer 42A that is formed on the Si substrate 41, and a second clad layer 42B that is formed on the first clad layer 42A. Furthermore, similarly, the optical transmitter/receiver 1 also includes the Si substrate 41 and the clad layer 42.

The first clad layer 42A is, for example, a SiO₂ layer that is made of SiO₂. The second clad layer 42B is, for example, a SiO₂ layer that is made of SiO₂. Each of the first Si waveguide 32A and the second Si waveguide 32E is a waveguide that is located in a lower layer arranged in the first clad layer 42A on the Si substrate 41. The LN waveguide 32C is a waveguide that is located in an upper layer formed on the second clad layer 42B.

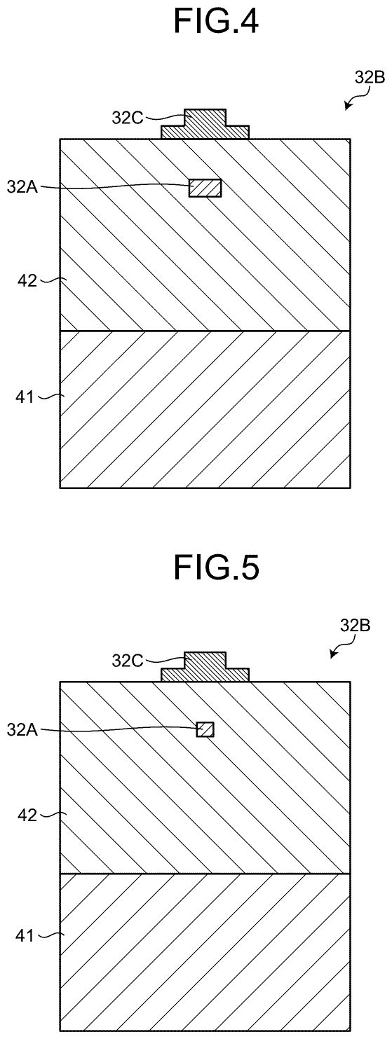

FIG. 4 is a cross-sectional schematic diagram illustrating one example of cross section taken along line A-A illustrated in FIG. 3. The first Si waveguide 32A illustrated in FIG. 4 is arranged inside the clad layer 42, and the LN waveguide 32C is arranged on the clad layer 42. In the first transition portion 32B, signal light is transitioned from the first Si waveguide 32A to the LN waveguide 32C as an interlayer transition.

FIG. 5 is a cross-sectional schematic diagram illustrating one example of cross section taken along line B-B illustrated in FIG. 3. The first Si waveguide 32A illustrated in FIG. 5 is arranged inside the clad layer 42, and the LN waveguide 32C is arranged on the clad layer 42. The first Si waveguide 32A has a tapered structure in which the waveguide width is gradually tapered toward the LN waveguide 32C. In the first transition portion 32B, signal light is transitioned from the first Si waveguide 32A to the LN waveguide 32C as an interlayer transition.

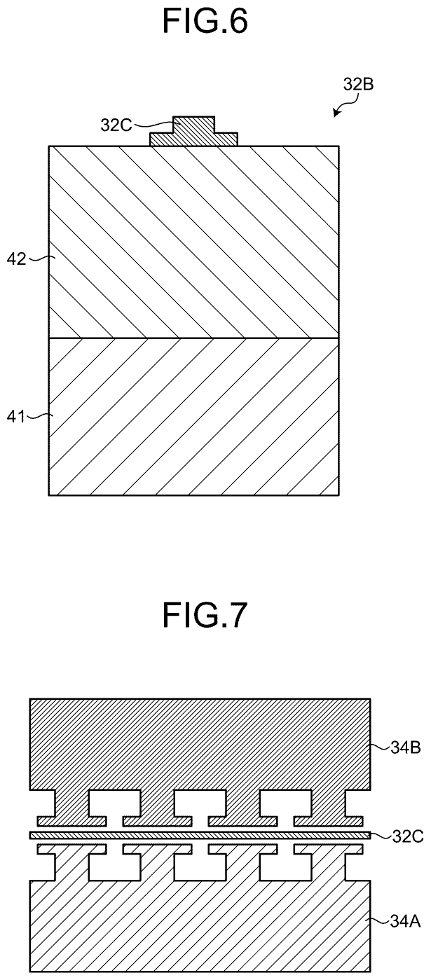

FIG. 6 is a cross-sectional schematic diagram illustrating one example of cross section taken along line C-C illustrated in FIG. 3. The first Si waveguide 32A has a structure in which the waveguide width is gradually narrow from the cross-sectional portion taken along line A-A illustrated in FIG. 3 toward the cross-sectional portion taken along line C-C illustrated in FIG. 3, and is terminated at the cross-sectional portion taken along line C-C illustrated in FIG. 3, as illustrated in FIG. 6. In the first transition portion 32B, the signal light confined in the first Si waveguide 32A is transitioned from the first Si waveguide 32A toward the LN waveguide 32C as an interlayer transition.

Furthermore, for convenience of description, the first transition portion 32B has been described on the basis of FIG. 4 to FIG. 6, and, in addition, the second transition portion 32D also has substantially the same configuration. The second Si waveguide 32E is, for example, a Si waveguide with a channel type having a tapered structure in which the waveguide width is gradually narrow toward the LN waveguide 32C. In the second transition portion 32D, the signal light confined in the LN waveguide 32C is transitioned from the LN waveguide 32C toward the second Si waveguide 32E as an interlayer transition.

The first Si waveguide 32A and the second Si waveguide 32E are disposed in the same layer. The LN waveguide 32C is disposed in the layer that is different from the layer in which the first Si waveguide 32A and the second Si waveguide 32E are disposed.

FIG. 7 is a schematic plan diagram illustrating one example of capacity loading type electrodes provided in the child MZM 22B. The RF electrode 34 is a capacity loading type electrode illustrated in FIG. 7. The RF electrode 34 includes the signal electrode 34A and the ground electrode 34B.

The portion that is included in the signal electrode 34A and that is arranged in parallel to the LN waveguide 32C is constituted by a plurality of T-shaped rails. Furthermore, the portion that is included in the ground electrode 34B and that is arranged in parallel to the LN waveguide 32C is also constituted by a plurality of T-shaped rails. The capacity loading type electrodes are constituted by a plurality of T-shaped rails, so that an available electrode size increases as a result of electric current being widely distributed. This is advantageous for a reduction in high frequency loss and may contribute to wider bandwidth. However, the refractive index of the electrical signal also increases affected by the capacity loading type electrodes in addition to an influence of the refractive index of the Si substrate 41. As a result, in a case where the velocity of the electrical signal in the RF electrode 34 is compared with the velocity of the signal light propagating through the LN waveguide 32C, the velocity of the electrical signal is slightly low. Therefore, it is conceivable that the bandwidth is limited due to velocity mismatch.

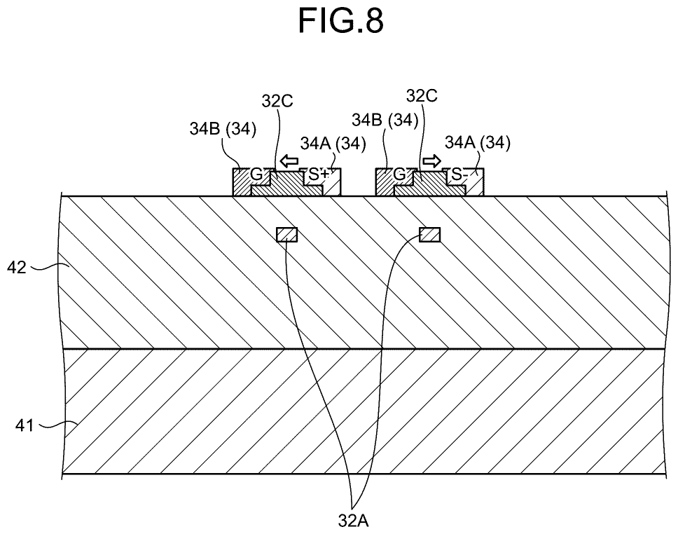

FIG. 8 is a cross-sectional schematic diagram illustrating one example of cross section taken along line A-A illustrated in FIG. 2. Each of the two optical waveguide arms 32 illustrated in FIG. 8 includes the Si substrate 41, the clad layer 42 that is formed on the Si substrate 41, and the first Si waveguides 32A that are formed in the clad layer 42. Each of the two optical waveguide arms 32 includes the LN waveguides 32C that are formed on the clad layer 42 and the RF electrode 34 that is arranged in parallel to the LN waveguides 32C. The RF electrode 34 includes the signal electrode 34A and the ground electrode 34B, and sandwiches the ridge portion of the LN waveguide 32C between the signal electrode 34A and the ground electrode 34B.

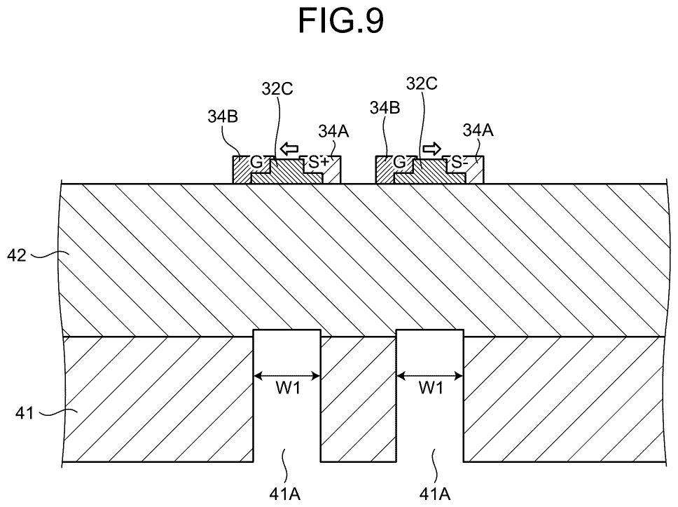

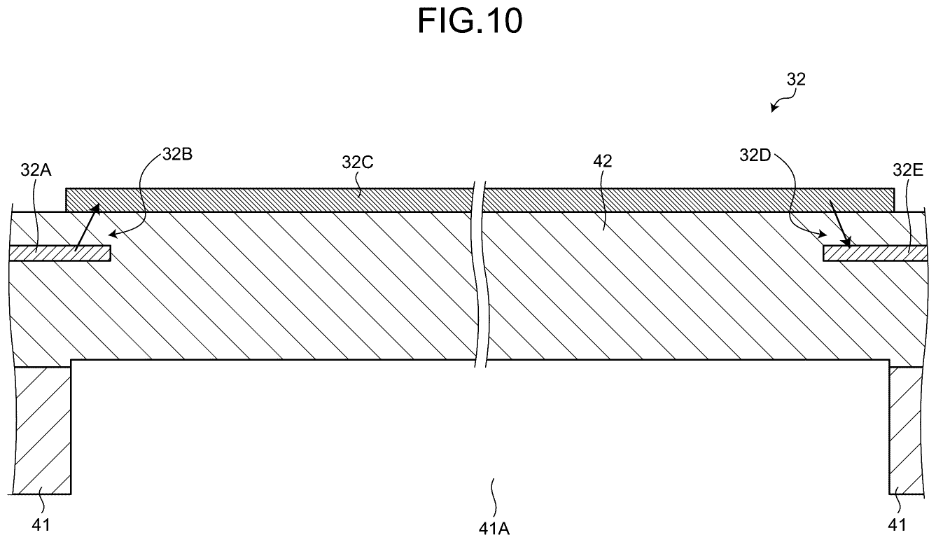

FIG. 9 is a cross-sectional schematic diagram illustrating one example of cross section taken along line B-B illustrated in FIG. 2, and FIG. 10 is a cross-sectional schematic diagram illustrating one example of cross section taken along line C-C illustrated in FIG. 2. Furthermore, the cross section taken along line C-C is a cross section of the two optical waveguide arms 32 in the waveguide direction. At the two optical waveguide arms 32 illustrated in FIG. 9 and FIG. 10, hollow portions 41A are formed in the Si substrate 41 that is located at a lower part of the LN waveguides 32C. Furthermore, the case has been described as an example in which the hollow portions 41A are formed in the Si substrate 41 that is located at the lower part of the LN waveguide 32C, but the hollow portions 41A may be formed in the Si substrate 41 that is located at the lower part of the LN waveguide 32C and in a part of the clad layer 42 at a position that is in contact with the Si substrate 41, and appropriate modifications are possible. Each of the hollow portions 41A is a space formed in the Si substrate 41 as a result of removing this portion by dry etching. An opening width W1 of each of the hollow portions 41A corresponds to a substrate removal width.

In each of the hollow portions 41A, a portion included in the Si substrate 41 corresponding to the width W1 has been removed all over the lower part of the LN waveguide 32C by using a method of dry etching or the like, but the clad layer 42 with a thickness of 4 μm remains in the lower part of the LN waveguide 32C. Consequently, high rigidity and strength that are sufficiently able to withstand a vibration test and an impact test are maintained in the LN waveguide 32C. This type of structure is also referred to as a membrane structure, and has high reliability due to a proven track record at the market of, for example, a tunable Si etalon filter or the like of external resonator laser.

The electric permittivity of air in the hollow portion 41A is “1”, the electric permittivity of the SiO₂ layer that is the clad layer 42 is about “4”, and the electric permittivity of Si is “12”; therefore, the electric permittivity of each of the hollow portion 41A and the clad layer 42 is smaller than the electric permittivity of the Si substrate 41. This means that the refractive index of the high frequency that a high frequency signal of electricity feels becomes low, and the velocity of a travelling high frequency signal becomes high. Consequently, the two optical waveguide arms 32 is able to match the velocity of the pieces of signal light propagating through the LN waveguides 32C and the velocity of the high frequency signal.

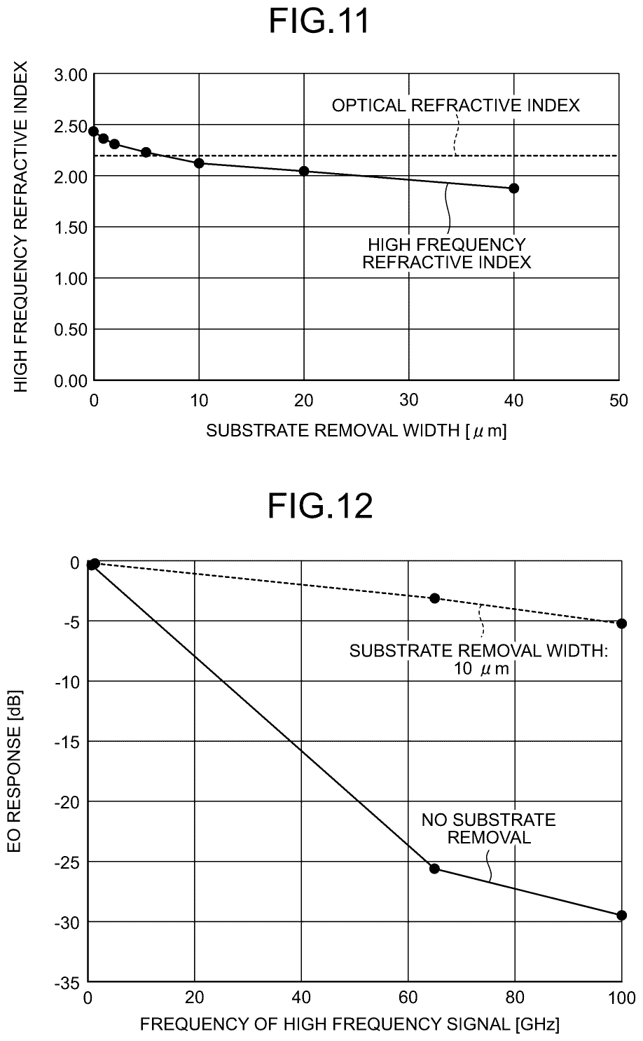

FIG. 11 is an explanation diagram illustrating one example of a relationship between a substrate removal width and the high frequency refractive index exhibited in the child MZM 22B. Furthermore, for convenience of description, it is assumed that a substrate removal width in a case where the hollow portion 41A of the Si substrate 41 that is conventionally used is not present is 0 μm. In a case where the substrate removal width is 0 μm, as illustrated in FIG. 11, the high frequency refractive index of the high frequency signal is 2.45, whereas the refractive index of the signal light propagating through the LN waveguide 32C is 2.2. Consequently, the high frequency refractive index of the high frequency signal is greater than the refractive index of light. On the other hand, in a case where the substrate removal width of the hollow portion 41A of the Si substrate 41 according to the present embodiment is, for example, 5 μm to 10 μm included in the range of 3 μm to 12 μm, the high frequency refractive index of the high frequency signal is about 2.2, and is substantially matched with the refractive index of the signal light propagating through the LN waveguide 32C.

FIG. 12 is an explanation diagram illustrating one example of frequency dependence of an EO response exhibited in the child MZM 22B. As illustrated in FIG. 12, in a case where substrate removal width of the hollow portion 41A is 10 μm, it is possible to substantially increase the EO response to the high frequency signal as compared to a case in which the substrate removal width is 0 μm.

The child MZM 22B (23B) according to the first embodiment includes the hollow portions 41A in the Si substrate 41 that is located at the lower part of the LN waveguides 32C included in the respective two optical waveguide arms 32. Consequently, it is possible to implement a wider bandwidth of the optical modulator element 2 by matching the velocity of the light propagating through each of the LN waveguides 32C and the velocity of the high frequency signal.

Furthermore, the case has been described as an example in which the RF electrode 34 provided in the child MZM 22B (23B) according to the first embodiment is, for example, the capacity loading type electrode, but an ordinary electrode may be used, and appropriate modifications are possible.

A case has been described as an example in which the hollow portions 41A provided in the child MZM 22B (23B) according to the first embodiment are formed in units of a single piece of the LN waveguide 32C included in the two optical waveguide arms 32. However, a single piece of the hollow portion 41A may be formed in units of the two LN waveguides 32C, and an embodiment thereof will be described as a second embodiment.

### (b) Second Embodiment

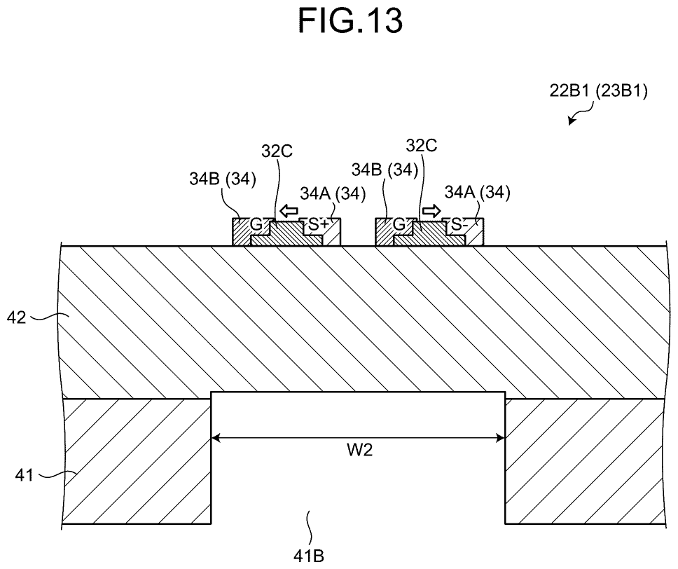

FIG. 13 is a cross-sectional schematic diagram illustrating one example of a child MZM 22B1 (23B1) according to the second embodiment. The cross-sectional schematic diagram illustrated in FIG. 13 is a cross section corresponding to a cross section taken along line B-B illustrated in FIG. 2. In addition, by assigning the same reference numerals to components having the same configuration as those in the optical transmitter/receiver 1 according to the first embodiment, overlapped descriptions of the configuration and the operation thereof will be omitted. The child MZM 22B1 (23B1) according to the second embodiment is different from the child MZM 22B (23B) according to the first embodiment in that a hollow portion 41B is formed in the Si substrate 41 that is located at a lower part of the two LN waveguides 32C in units of the two LN waveguides 32C.

The hollow portion 41B illustrated in FIG. 13 is formed in the Si substrate 41 that is located at the lower part of the two LN waveguides 32C included in the two optical waveguide arms 32 by performing dry etching. The opening width W2 of the hollow portion 41B is made wider than the opening width W1 of the hollow portion 41A according to the first embodiment.

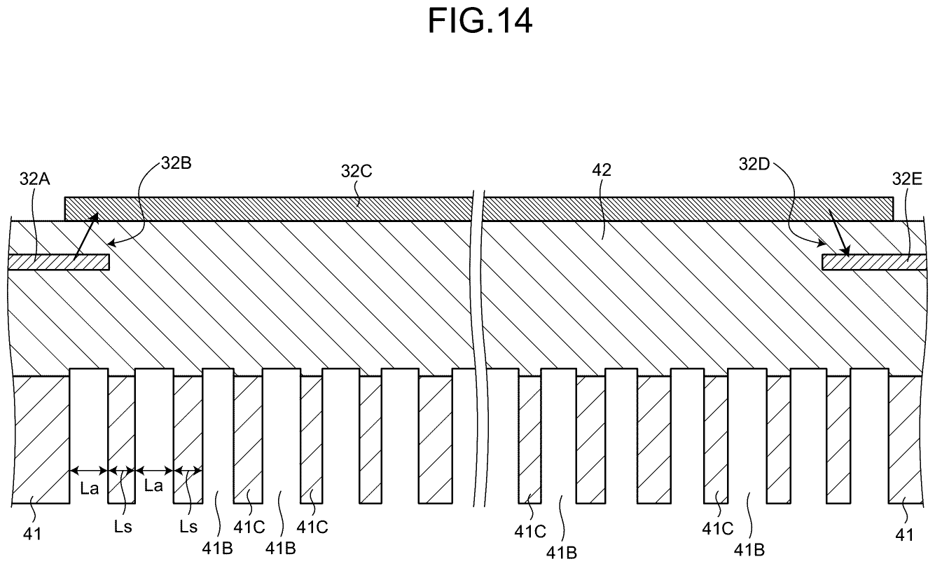

FIG. 14 is a cross-sectional schematic diagram of one example of the child MZM 22B1 (23B1) according to the second embodiment. The cross-sectional schematic diagram illustrated in FIG. 14 is a cross section corresponding to a cross section taken along line C-C illustrated in FIG. 2. The hollow portions 41B illustrated in FIG. 14 are formed in the Si substrate 41 at predetermined intervals of the waveguide direction of the LN waveguide 32C.

In the Si substrate 41 that is located at the lower part of the two LN waveguides 32C, the hollow portions 41B and residual portions 41C are included. Each of the hollow portions 41B has the opening width W2 of the two optical waveguide arms 32 in the width direction and an opening width La of the two optical waveguide arms 32 in the waveguide direction. The opening width W2 of each of the hollow portions 41B is, for example, 80 μm. Each of the residual portions 41C has a width Ls in the waveguide direction of the residual portion 41C that is located between the hollow portions 41B. The thickness of each of the residual portion 41C located at the lower part of the two LN waveguides 32C is, for example, 4 μm.

A plurality of the residual portions 41C are included in the lower part of the two LN waveguides 32C, so that the LN waveguide 32C is able to ensure high rigidity and strength that are sufficiently able to withstand, for example, a vibration test and an impact test.

In a case where the opening width W2 of each of the hollow portions 41B is wide having a width equal to or greater than 80 μm, in a case of the structure in which the Si substrate 41 is removed all over the waveguide direction described above in the first embodiment (=the structure in which a substrate removal rate is 100%), the refractive index of the high frequency becomes equal to or less than 2.0. Therefore, it is conceivable that a velocity mismatch occurs as a result of the velocity of the high frequency signal being too high with respect to the refractive index of light of 2.2.

On the other hand, with the structure in which only a part of the Si substrate 41 is removed in the direction along the LN waveguide 32C, the refractive index of the high frequency signal is adjusted by changing a removal rate of the Si substrate 41, and an appropriate removal rate is obtained. Consequently, it is possible to match the velocity of the pieces of signal light propagating through the LN waveguide 32C and the velocity of the high frequency signal.

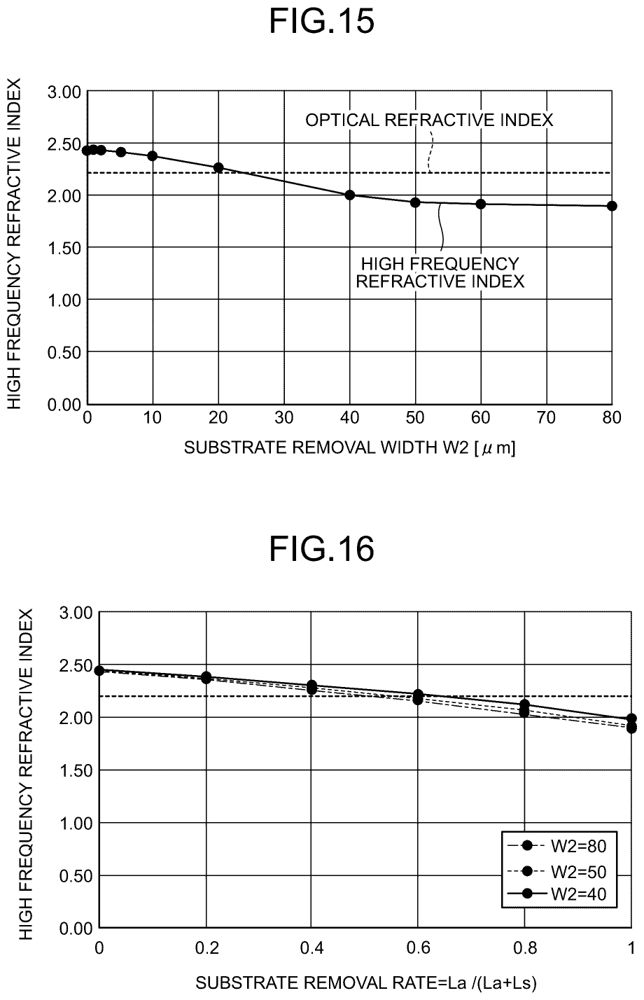

FIG. 15 is an explanation diagram illustrating one example of a relationship between the substrate removal width W2 and the high frequency refractive index exhibited in the child MZM 22B. In a case where the opening width W2 of the hollow portion 41B is 40 μm to 80 μm, if the substrate removal rate is referred to as 100% by removing the region of the Si substrate 41 corresponding to all of the lower part of the two LN waveguides 32C, the refractive index of the high frequency signal becomes 1.9, whereas the refractive index of the signal light propagating through the LN waveguide 32C becomes 2.2.

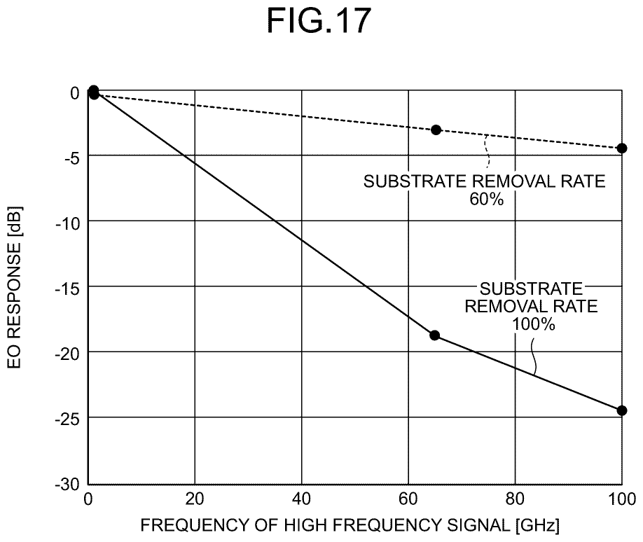

FIG. 16 is an explanation diagram illustrating one example of a relationship between the substrate removal rate for each substrate removal width and the high frequency refractive index, and FIG. 17 is an explanation diagram illustrating one example of frequency dependence of the EO characteristic for each substrate removal rate exhibited in the child MZM 22B1 (23B1). As described above in the second embodiment, in a case where the substrate removal rate is assumed to be 60% by arranging the hollow portion 41B with La of 30 μm and the residual portion 41C with Ls of 20 μm located at the lower part of the two LN waveguides 32C at predetermined intervals, as illustrated in FIG. 16, the refractive index of the high frequency signal becomes about 2.2. Consequently, the refractive index of the signal light propagating through the LN waveguide 32C and the refractive index of the high frequency signal are substantially matched.

In also a case where the opening width W2 of the hollow portion 41B is set to 40 μm to 80 μm, it is possible to broaden the band width of the EO response in the same manner as that described in the first embodiment. Furthermore, in a case where it is assumed that an arm interval is 40 μm and the substrate removal rate that is defined by La/(La+Ls) is 100%, even if the removal width of the Si substrate 41 in a region corresponding to the lower part of the LN waveguide 32C included in the arm is changed, the refractive index of the high frequency signal is not changed in a case where the removal width is equal to or greater than 40 μm. Therefore, it is preferable that the width of the Si substrate 41 that is located in a region corresponding to the lower part of the LN waveguide 32C included in the arm and that is to be removed is set to the width equal to or greater than the arm interval, and it is preferable that, as illustrated in FIG. 16, the substrate removal rate that is defined by La/(La+Ls) is 40% (0.4) to 80% (0.8).

Furthermore, the opening width W2, the opening width La, and the width Ls are not limited to those described above, and appropriate modifications are possible as long as it is possible to broaden the EO bandwidth by substantially matching the refractive index of the high frequency signal and the refractive index of the signal light. Moreover, the case has been described as an example in which the hollow portion 41B and the residual portion 41C are arranged at regular intervals in the Si substrate 41 that is located in a region corresponding to the lower part of the two LN waveguides 32C according to the second embodiment. However, the hollow portion 41B and the residual portion 41C do not always need to be arranged at regular intervals as long as it is possible to broaden the EO bandwidth by substantially matching the refractive index of the high frequency signal and the refractive index of the signal light, and appropriate modifications are possible.

The case has been described as an example in which, in the child MZM 22B1 (23B1) according to the second embodiment, the hollow portion 41B and the residual portion 41C are formed by removing a part of the Si substrate 41 that is located in a region corresponding to the lower part of the two LN waveguides 32C. However, it may be possible to form a hollow portion and a residual portion by removing a part of the Si substrate 41 that is located in a region corresponding to the lower part of the single piece of the LN waveguide 32C included in the child MZM 22B (23B) according to the first embodiment, and appropriate modifications are possible.

In the LN waveguides 32C included in the child MZMs 22B and 22B1 (23B and 23B1) according to the first and the second embodiments, a Pockels coefficient representing the electro-optical effect is low, that is, about 30 pm/V. Therefore, to increase the modulation efficiency such that the driver circuit is driven by a practical amplitude voltage, as illustrated in FIG. 2, the length of the modulator arm needs to be 10 mm or more. Consequently, it is not possible to take advantage of economies of scale that is an advantage of the SiPh element. Accordingly, an embodiment of solving this circumstance will be described below as a third embodiment.

### (c) Third Embodiment

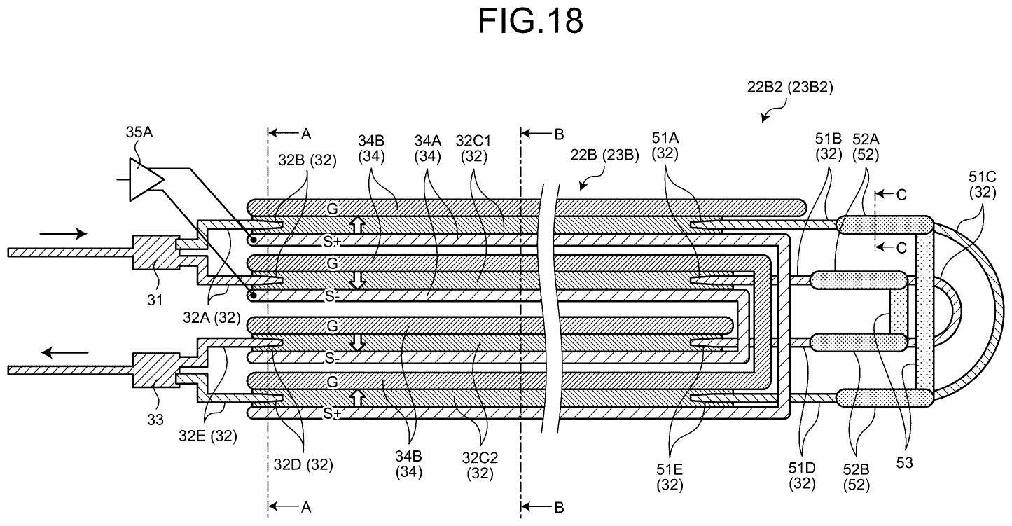

FIG. 18 is a cross-sectional schematic diagram illustrating one example of a child MZM 22B2 (23B2) according to the third embodiment. Furthermore, for convenience of description, by assigning the same reference numerals to components having the same configuration as those in the optical transmitter/receiver 1 according to the second embodiment, overlapped descriptions of the configuration and the operation thereof will be omitted. Furthermore, also, the child MZM 23B2 has the same configuration as that of the child MZM 22B2; therefore, by assigning the same reference numerals to components having the same configuration as those in the child MZM 22B2, overlapped descriptions of the configuration and the operation thereof will be omitted. The child MZM 22B2 (23B2) according to the third embodiment is different from the child MZM 22B1 (23B1) according to the second embodiment in that the two optical waveguide arms 32 are formed to have a folded structure.

The child MZM 22B2 includes the branching portion 31, the two optical waveguide arms 32, the multiplexing portion 33, and the RF electrode 34. The branching portion 31 is a branching portion that is made of, for example, Si and that branches and outputs the signal light received from the second branching portion 22A (23A) to each of the first Si waveguides 32A included in the respective two optical waveguide arms 32. The two optical waveguide arms 32 include the two first Si waveguides 32A, the two first transition portions 32B, and two first LN waveguides 32C1, respectively. The two optical waveguide arms 32 include two third transition portions 51A, two third Si waveguides 51B, two folded waveguides 51C, two fourth Si waveguides 51D, and two fourth transition portions 51E, respectively. The two optical waveguide arms 32 include the two second LN waveguides 32C2, the two second transition portions 32D, and the two second Si waveguides 32E, respectively.

The first Si waveguide 32A is a Si waveguide with, for example, a channel type. The first Si waveguide 32A is a tapered waveguide in which one end of the waveguide width is formed to have a tapered shape. The first LN waveguide 32C1 is a LN waveguide with, for example, a ridge type. The third Si waveguide 51B is a Si waveguide with, for example, a channel type that is connected to the folded waveguide 51C. The third Si waveguide 51B is a tapered waveguide in which one end of the waveguide width is formed to have a tapered shape. The folded waveguide 51C is a Si waveguide with a channel type formed to have a U-shaped folded structure with a small bend radius because the folded waveguide 51C strongly confines light.

The fourth Si waveguide 51D is a Si waveguide with, for example, a channel type that is connected to the folded waveguide 51C. The fourth Si waveguide 51D is a tapered waveguide in which one end of the waveguide width is formed to have a tapered shape. The second LN waveguide 32C2 is a LN waveguide with, for example, a ridge type. The second Si waveguide 32E is a Si waveguide with, for example, a channel type. The second Si waveguide 32E is a tapered waveguide in which one end of the waveguide width is formed to have a tapered shape.

The first transition portion 32B is an interlayer transition portion in which signal light is optically transitioned between the first Si waveguide 32A and the first LN waveguide 32C1 in the respective layers. The RF electrode 34 includes the signal electrodes 34A that are arranged in parallel to the respective waveguides included in the two respective optical waveguide arms 32, and the ground electrodes 34B that are arranged in parallel to the respective waveguides included in the two respective optical waveguide arms 32. In a case where the high frequency signal received from a driver circuit 35A is input, each of the signal electrodes 34A modulates the signal light propagating through the first LN waveguide 32C1 that is arranged between the ground electrode 34B and the signal electrode 34A.

The third transition portion 51A is an interlayer transition portion in which signal light is optically transitioned between the first LN waveguide 32C1 and the third Si waveguide 51B in the respective layers. The fourth transition portion 51E is an interlayer transition portion in which signal light is optically transitioned between the fourth Si waveguide 51D and the second LN waveguide 32C2 in the respective layers. In a case where the high frequency signal received from the driver circuit 35A is input, the signal electrode 34A modulates the signal light propagating through the second LN waveguide 32C2 that is arranged between the ground electrode 34B and the signal electrode 34A.

The second transition portion 32D is an interlayer transition portion in which signal light is optically transitioned between the second LN waveguide 32C2 and the second Si waveguide 32E in the respective layers. The multiplexing portion 33 is a multiplexing portion that is made of, for example, Si, that multiplexes the signal light received from each of the second Si waveguides 32E, and that outputs the multiplexed signal light to the parent DC phase shifter 22C (23C).

The two optical waveguide arms 32 couple a portion between the first LN waveguide 32C1 and the second LN waveguide 32C2 by the folded waveguide 51C, so that it is possible to reduce the size of the longitudinal direction to ½ as compared to the size of that of the LN waveguide 32C according to the first embodiment.

The child MZM 22B2 includes first heater electrodes 52A that are arranged near the third Si waveguide 51B, second heater electrode 52B that are arranged near the fourth Si waveguide 51D, and electrode wiring 53. The electrode wiring 53 is metal wiring that injects an electric current into the first heater electrode 52A and that injects an electric current into the second heater electrode 52B.

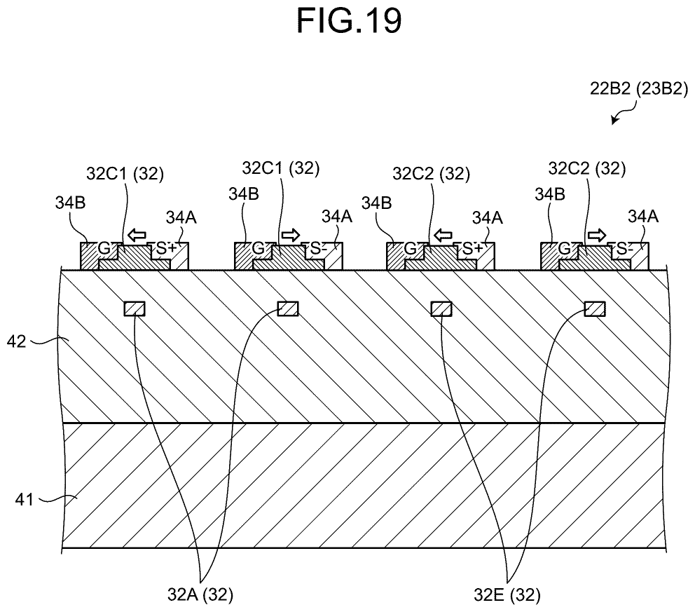

FIG. 19 is a cross-sectional schematic diagram illustrating one example of a cross section taken along line A-A illustrated in FIG. 18. Each of the two optical waveguide arms 32 illustrated in FIG. 19 includes the Si substrate 41, the clad layer 42 that is formed on the Si substrate 41, the first Si waveguides 32A that are formed in the clad layer 42, and the second Si waveguides 32E that are formed in the clad layer 42. The first Si waveguides 32A and the second Si waveguides 32E are formed in the same layer.

Each of the two optical waveguide arms 32 includes the first LN waveguide 32C1 that is formed on the clad layer 42, the second LN waveguide 32C2 that is formed on the clad layer 42, and the RF electrode 34 that is arranged in parallel to the first LN waveguide 32C1 and the second LN waveguide 32C2. The first LN waveguides 32C1 and the second LN waveguides 32C2 are formed in the same layer. Each of the first LN waveguides 32C1 is arranged in parallel between the associated signal electrode 34A and the associated ground electrode 34B. Each of the second LN waveguides 32C2 is arranged in parallel between the associated signal electrode 34A and the associated ground electrode 34B. The first LN waveguides 32C1 and the second LN waveguides 32C2 are formed in the layer that is different from the layer in which the first Si waveguides 32A and the second Si waveguides 32E are arranged.

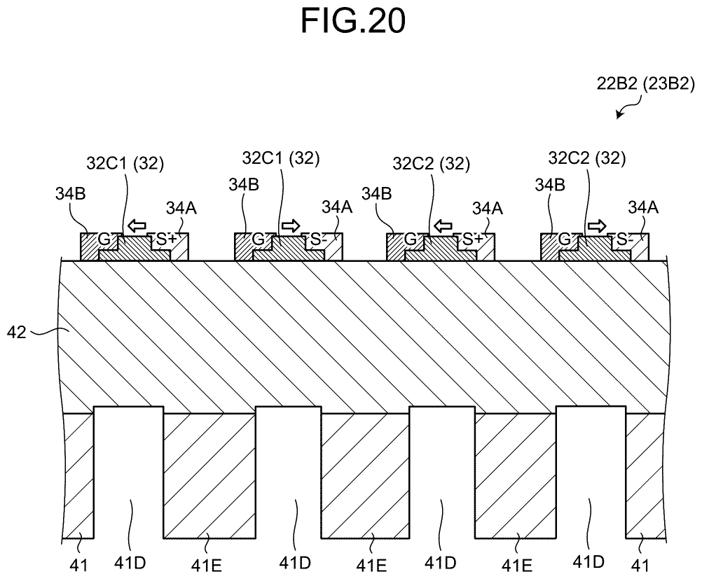

FIG. 20 is a cross-sectional schematic diagram illustrating one example of cross section taken along line B-B illustrated in FIG. 18. Hollow portions 41D and residual portions 41E are included in the Si substrate 41 that is located at the lower part of the first LN waveguide 32C1 and the second LN waveguide 32C2. A plurality of the residual portions 41E are included in the lower part of each of the first LN waveguide 32C1 and the second LN waveguide 32C2, so that the first LN waveguides 32C1 and the second LN waveguides 32C2 are able to ensure high rigidity and strength that are sufficiently able to withstand, for example, a vibration test and an impact test.

The electric permittivity of air in the hollow portion 41D “1”, the electric permittivity of the SiO₂ layer that is the clad layer 42 is about “4”, and the electric permittivity of Si is “12”; therefore, the electric permittivity of each of the hollow portion 41D and the clad layer 42 is smaller than the electric permittivity of the Si substrate 41. This means that the refractive index of the high frequency signal that a high frequency signal of electricity feels becomes low, and the velocity of a travelling high frequency signal becomes high. Consequently, it is possible to match the velocity of the pieces of signal light propagating through both of the first LN waveguides 32C1 and the second LN waveguides 32C2 and the velocity of the high frequency signal.

The signal electrode 34A includes a first signal electrode arranged in the vicinity of the first LN waveguide 32C1, a second signal electrode arranged in the vicinity of the second LN waveguide 32C2, and a U-shaped signal electrode that electrically connects a portion between the first signal electrode and the second signal electrode. Each of the ground electrodes 34B includes a first ground electrode arranged in the vicinity of the first LN waveguide 32C1, a second ground electrode arranged in the vicinity of the second LN waveguide 32C2, and a U-shaped ground electrode that electrically connects a portion between the first ground electrode and the second ground electrode.

The child MZM 22B2 is connected to the driver circuit 35A that has a differential drive type. The driver circuit 35A is connected to the first signal electrode included in the signal electrode 34A and the second signal electrode included in the signal electrode 34A. The driver circuit 35A allows a high frequency signal to propagate through both of the first signal electrode and the first LN waveguide 32C1 in the same electric field direction, and allows a high frequency signal to both of the second signal electrode and the second LN waveguide 32C2 in the same electric field direction, so that it is possible to avoid the situation in which phases of modulation are cancelled out.

In a case where a driver circuit with an open collector type that is distributed to the market is used as the driver circuit 35A with a differential drive type and a DC voltage is applied to each of the first LN waveguide 32C1 and the second LN waveguide 32C2, it is conceivable that a DC drift of an operating point voltage of the LN modulator occurs. However, in the child MZM 22B2 according to the third embodiment, a phase shifter including a heater electrode 52 that compensates the DC drift is arranged. The first phase shifter includes the third Si waveguide 51B, and the first heater electrode 52A that is formed at the lower part of the third Si waveguide 51B. Furthermore, the second phase shifter includes the fourth Si waveguide 51D, and the second heater electrode 52B that is formed at the lower part of the fourth Si waveguide 51D.

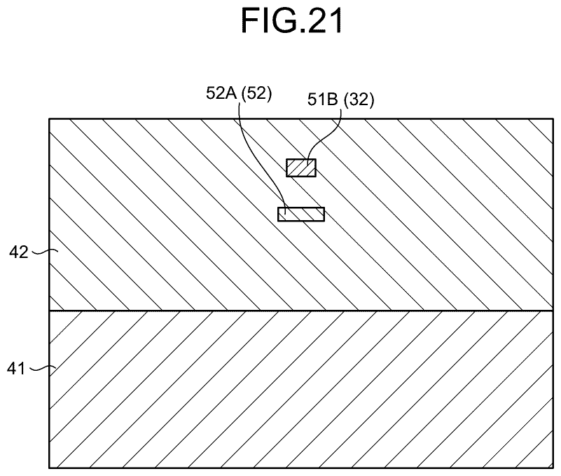

FIG. 21 is a cross-sectional schematic diagram illustrating one example of cross section taken along line C-C illustrated in FIG. 18. The cross-sectional part illustrated in FIG. 21 is the cross-sectional part of the first phase shifter. Furthermore, for convenience of description, the second phase shifter also has the same configuration as that of the first phase shifter; therefore, by assigning the same reference numerals to components having the same configuration thereof, overlapped descriptions of the configuration and the operation thereof will be omitted. The first phase shifter illustrated in FIG. 21 includes the Si substrate 41, the clad layer 42, the third Si waveguide 51B that is formed in the clad layer 42, and the first heater electrode 52A that is formed in the clad layer 42 and that is formed at the lower part of the third Si waveguide 51B.

The first phase shifter heats the first heater electrode 52A by flowing an electric current into the first heater electrode 52A, and heats the third Si waveguide 51B by heat generated by the first heater electrode 52A. As a result of the third Si waveguide 51B being heated, the refractive index of the third Si waveguide 51B increases, so that the first phase shifter adjusts the phase of the signal light propagating through the third Si waveguide 51B. As a result of the phase of the signal light being adjusted, it is possible to control the operating point voltage by an external auto bias control (ABC) circuit, so that it is possible to compensate a DC drift. The Si waveguide itself does not generate a DC drift, so that it is relatively easily secure the life of the DC drift. In addition, a change in refractive index due to a temperature is great in Si, so that it is possible to suppress electrical power consumed in a heater. Furthermore, it is possible to form the heater electrode 52 by a manufacturing process used in SiPh.

### (d) Fourth Embodiment

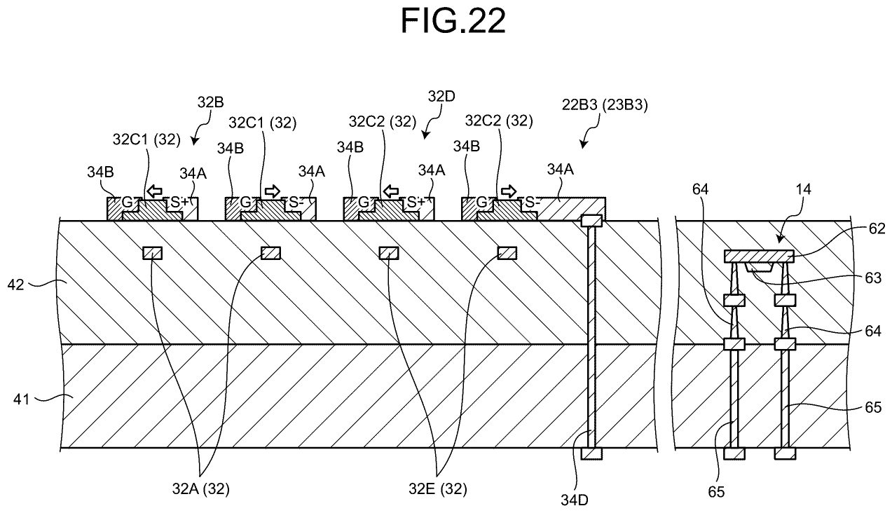

FIG. 22 is a cross-sectional schematic diagram illustrating one example of a child MZM 22B3 (23B3) according to a fourth embodiment. In addition, by assigning the same reference numerals to components having the same configuration as those in the optical transmitter/receiver 1 according to the first embodiment, overlapped descriptions of the configuration and the operation thereof will be omitted. The optical transmitter/receiver 1 according to the fourth embodiment includes the optical modulator element 2 formed by using a method of 2.5 dimensional packaging, and the optical receiver element 3 formed by using the method of 2.5 dimensional packaging. The optical transmitter/receiver 1 according to the fourth embodiment is different from the optical transmitter/receiver 1 according to the first embodiment in that the child MZM 22B3 (23B3) is arranged instead of the child MZM 22B (23B). The cross-sectional part illustrated in FIG. 22 is a cross-sectional parts of the first transition portion 32B included in the child MZM 22B3 (23B3), the second transition portion 32D included in the child MZM 22B3 (23B3), and the PD 14.

The first transition portion 32B included in the child MZM 22B3 includes the Si substrate 41, the clad layer 42, the first Si waveguide 32A that is formed in the clad layer 42, the first LN waveguide 32C1 that is formed on the clad layer 42, the signal electrode 34A, and the ground electrode 34B. The second transition portion 32D included in the child MZM 22B3 includes the Si substrate 41, the clad layer 42, the second Si waveguide 32E that is formed in the clad layer 42, the second LN waveguide 32C2 that is formed on the clad layer 42, the signal electrode 34A, and the ground electrode 34B.

The child MZM 22B3 includes a through Si via (TSV) 34D that passes through a portion between the top surface of the clad layer 42 and the top surface of the Si substrate 41, and that electrically connects a portion between the signal electrode 34A that is arranged on the top surface of the clad layer 42 and the electrode pad that is arranged on the top surface of the Si substrate 41.

The PD 14 includes the Si substrate 41, the clad layer 42, a Si layer 62 that is formed in the clad layer 42, a Ge layer 63 that is formed in the clad layer 42 and that is in contact with the Si layer 62, and vias 64. Each of the via 64 passes through a portion between the Si layer 62 and the pad electrode between the clad layer 42 and the Si substrate 41, and electrically connects a portion between the Si layer 62 and the electrode pad located between the clad layer 42. The PD 14 includes vias 65 each of which passes through a portion between the electrode pad located on the top surface of the Si substrate 41 and the electrode pad located between the clad layer 42 and Si substrate 41, and that electrically connects a portion between the electrode pad on the Si substrate 41 and the electrode pad between the clad layer 42 and the Si substrate 41.

It is preferable to decrease surface roughness of the top surface of the clad layer 42 in which the first LN waveguide 32C1 and the second LN waveguide 32C2 are integrally mounted is by chemical mechanical polishing (CMP). Furthermore, the distance between the first LN waveguide 32C1 and the first Si waveguide 32A in the height direction included in the first transition portion 32B is assumed to be within, for example, 1500 nm. The distance between the second LN waveguide 32C2 and the second Si waveguide 32E in the height direction included in the second transition portion 32D is assumed to be, for example, 1500 nm.

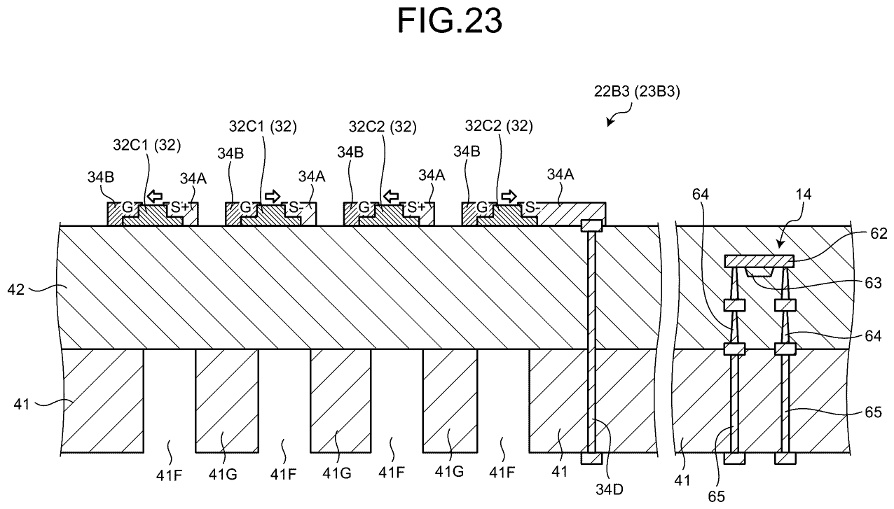

FIG. 23 is a schematic plan diagram illustrating one example of the child MZM 22B3 (23B3) according to the fourth embodiment. In the Si substrate 41 that is located at the lower part of the first LN waveguide 32C1 and the second LN waveguide 32C2, a hollow portion 41F and a residual portion 41G are included. A plurality of the residual portions 41G are included in the lower part of the first LN waveguide 32C1 and the second LN waveguide 32C2, so that the first LN waveguide 32C1 and the second LN waveguide 32C2 are able to ensure high rigidity and strength that are sufficiently able to withstand, for example, a vibration test and an impact test.

The electric permittivity of air in the hollow portion 41F “1”, the electric permittivity of the SiO₂ layer that is the clad layer 42 is about “4”, and the electric permittivity of Si is “12”; therefore, the electric permittivity of each of the hollow portion 41F and the clad layer 42 is smaller than the electric permittivity of the Si substrate 41. This means that the refractive index of the high frequency that a high frequency signal of electricity feels becomes low, and the velocity of a travelling high frequency signal becomes high. Consequently, it is possible to match the velocity of the pieces of signal light propagating through the first LN waveguide 32C1 and the second LN waveguide 32C2 and the velocity of the high frequency signal.

However, the SiPh wafer has a laminated structure constituted by multi layers including a metal wiring layer, an insulation layer, and the like, and the distance between the Si waveguide and the top surface is equal to or greater than 7000 nm. Therefore, it is not possible to perform a CMP process within 1500 nm regarding the distance between the first transition portion 32B that is made of Si and the top surface of the clad layer 42.

The SiPh wafer is temporarily bonded to a different Si substrate serving as a handle substrate, and the Si substrate (not illustrated) located on the SiPh wafer side is removed from the back surface by using a grinding and polishing process. At this time, a PD 14 including a Ge layer 63 is vertically inverted, thereby having a vertically structured relationship as illustrated in FIG. 22. All of the first Si waveguide 32A included in the first transition portion 32B, the second Si waveguide 32E included in the second transition portion 32D, and a Si layer 62 that abuts against the Ge layer 63 included in the PD 14, that has been doped, and that has the conductive property are located in the Si layer of SOI corresponding to the source of the SiPh wafer, are located at the same height.

Here, vias 64 that are electrically connected to the Si layer 62A included in the PD 14 are buried in the Si substrate 41, so that there is a need to draw up the electrodes to the top surface of the Si substrate 41 by a TSV 65. When the TSV 65 is manufactured, there is a need to create a hole in the Si substrate 41 by dry etching, it is possible to form partial hollow portions 41F in the Si substrate 41 illustrated in FIG. 23 by dry etching at the time of manufacturing the TSV. Therefore, the hollow portions 41F formed in the Si substrate 41 do not a large increase in cost.

The optical transmitter/receiver 1 according to the fourth embodiment includes the optical modulator element 2 formed by using a method of 2.5 dimensional packaging and the optical receiver element 3 formed by using the method of 2.5 dimensional packaging. It is possible to implement the optical modulator element 2 and the optical receiver element 3 that are formed by using the method of 2.5 dimensional packaging.

### (e) Fifth Embodiment

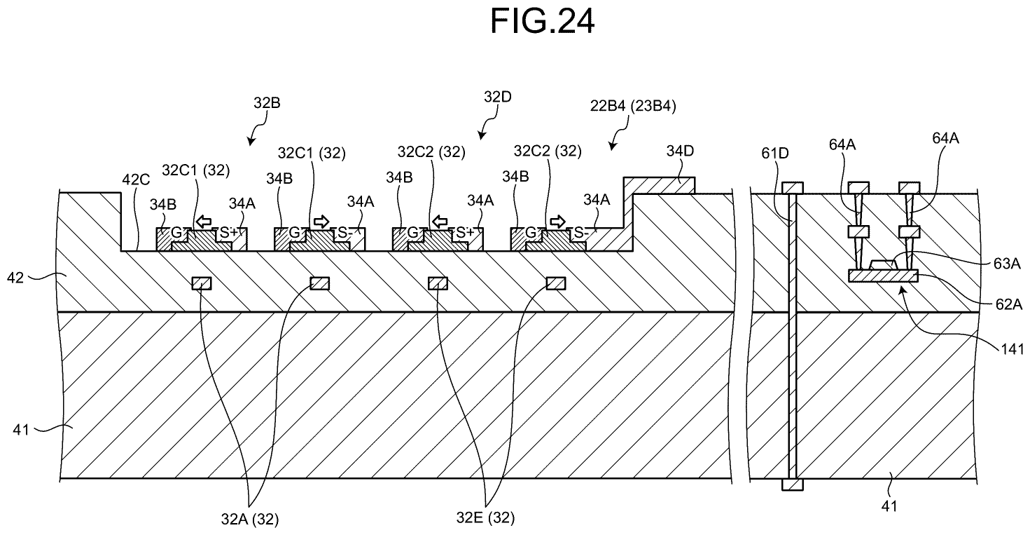

FIG. 24 is a cross-sectional schematic diagram illustrating one example of a child MZM 22B4 (23B4) according to the fifth embodiment. In addition, by assigning the same reference numerals to components having the same configuration as those in the optical transmitter/receiver 1 according to the first embodiment, overlapped descriptions of the configuration and the operation thereof will be omitted. The optical transmitter/receiver 1 according to the fifth embodiment is different from the optical transmitter/receiver 1 according to the first embodiment in that the child MZM 22B4 (23B4) and the PD 141 are arranged instead of the child MZM 22B (23B) and the PD 14. The cross-sectional part illustrated in FIG. 24 is a cross-sectional part of the first transition portion 32B included in the child MZM 22B4 (23B4), the second transition portion 32D included in the child MZM 22B4 (23B4), and the PD 141.

The first transition portion 32B included in the child MZM 22B4 includes the Si substrate 41, the clad layer 42, the first Si waveguide 32A that is formed in the clad layer 42, and a hollow portion 42C that is formed in the clad layer 42. The first transition portion 32B includes the first LN waveguide 32C1, the signal electrodes 34A, and the ground electrodes 34B that are formed in the hollow portion 42C. The hollow portion 42C is formed by digging a part of the clad layer 42 in a grooved shape by dry etching. The second transition portion 32D included in the child MZM 22B4 includes the Si substrate 41, the clad layer 42, the second Si waveguide 32E that is formed in the clad layer 42, and the hollow portion 42C. The second transition portion 32D includes the second LN waveguide 32C2, the signal electrodes 34A, and the ground electrodes 34B that are formed in the hollow portion 42C.

The PD 141 includes the Si substrate 41, the clad layer 42, the Si layer 62A that is formed in the clad layer 42, the Ge layer 63A that is formed in the clad layer 42 and that is formed on the Si layer 62A. The PD 14 includes the vias 64A each of which passes through a portion between the Si layer 62A and the electrode pad located on the top surface of the clad layer 42, and electrically connects the Si layer 62A and the electrode pad that is located on the clad layer 42. The PD 141 includes a TSV 61D that passes through a portion between the electrode pad that is located on the top surface of the Si substrate 41 and the electrode pad that is located on the top surface of the clad layer 42, and that electrically connects the electrode pad located on the Si substrate 41 and the electrode pad located on the clad layer 42.

The distance between the first LN waveguide 32C1 and the first Si waveguide 32A in the height direction included in the first transition portion 32B is set to within, for example, 1500 nm. The distance between the second LN waveguide 32C2 and the second Si waveguide 32E in the height direction included in the second transition portion 32D is set to within, for example, 1500 nm.

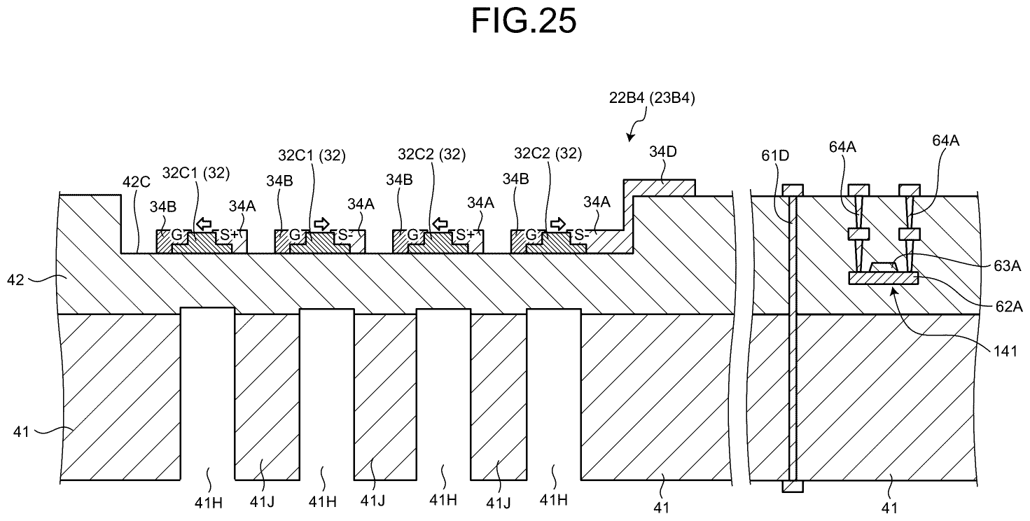

FIG. 25 is a schematic plan diagram illustrating one example of the child MZM 22B4 according to the fifth embodiment. In the Si substrate 41 that is located at the lower part of the first LN waveguide 32C1 and the second LN waveguide 32C2, hollow portions 41H and residual portions 41J are included. The plurality of residual portions 41J are included in the lower part of the first LN waveguide 32C1 and the second LN waveguide 32C2, so that the first LN waveguides 32C1 and the second LN waveguides 32C2 are able to ensure high rigidity and strength that are sufficiently able to withstand, for example, a vibration test and an impact test.

In the child MZM 22B4 according to the fifth embodiment, as compared to the child MZM 22B3 according to the fourth embodiment, there is no need to perform CMP process on all of the area of the top surface of the clad layer 42. It is possible to set the distance between the first LN waveguide 32C1 and the first Si waveguide 32A in the height direction included in the first transition portion 32B and the distance between the second LN waveguide 32C2 and the second Si waveguide 32E in the height direction included in the second transition portion 32D to within 1500 nm, and also set the distance between the Si waveguide layer and the top surface that is determined in accordance with a multi-layer laminated structure constituted by the metal wiring layer, the insulation layer, and the like formed in the SiPh wafer to 7000 nm or above in a compatible manner.

In addition, in the child MZM 22B4 according to the fifth embodiment, as compared to the child MZM 22B3 according to the fourth embodiment, there is no need to temporarily bond the SiPh wafer to a different Si substrate serving as a handle substrate. In this case, the PD 141 that includes the Ge layer 63A is not vertically inverted, thereby having a vertically structured relationship illustrated in FIG. 24. Here, all of the first Si waveguide 32A, the second Si waveguide 32E, and the Si layer 62A are formed in the Si layer of SOI corresponding to the source of the SiPh wafer, and are located at the same height.

Furthermore, the electrodes provided in the PD 141 are able to use the via 64A that is manufactured in an ordinary SiPh wafer and that is electrically connected to the doped Si layer 62A having the conductive property located in the PD 141 without any change, and are connected to a transimpedance amplifier (TIA). On the other hand, the electrodes provided in the child MZM 22B4 is connected to the driver circuit 35A by way of the connecting electrode 34D that is running up from the signal electrode 34A that is located on the bottom surface of the hollow portion 42C to the top surface. Furthermore, the TSV 61D passing through the Si substrate 41 in order for the 2.5 dimensional packaging is used to be connected to an interposer wiring substrate (not illustrated) that is located on the back surface side of the Si substrate 41. However, when the TSV 61D is manufactured, there is a need to create a hole in the Si substrate 41 by dry etching, the hollow portions 41H that are partial portions of the Si substrate 41 illustrated in FIG. 25 are able to create at the same time when the TSV is formed by dry etching. Therefore, forming of the hollow portions 41H does not a large increase in cost.

### (f) Sixth Embodiment

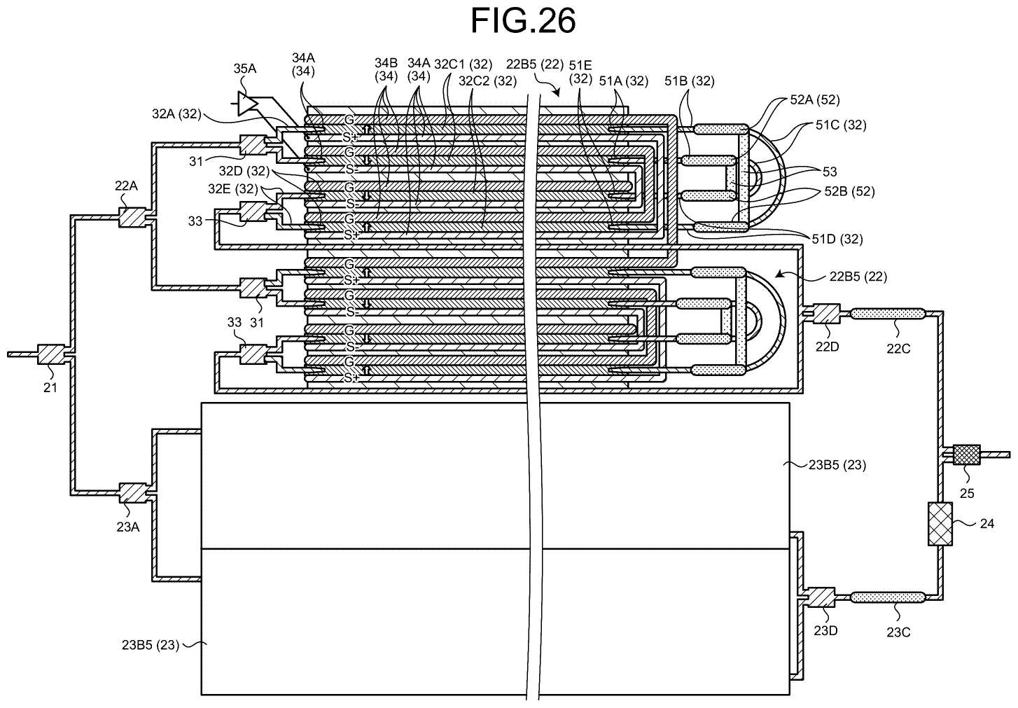

FIG. 26 is a schematic plan diagram illustrating one example of a modulator according to a sixth embodiment. In addition, by assigning the same reference numerals to components having the same configuration as those in the optical transmitter/receiver 1 according to the third embodiment, overlapped descriptions of the configuration and the operation thereof will be omitted. The modulator includes the X polarization modulation unit 22 constituted by two single type MZMs operating at a baud rate of 200 G, and the Y polarization modulation unit 23 constituted by two single type MZMs. The modulator is MZM using a dual polarization-quadrature amplitude modulation (DP-QAM) method.

The X polarization modulation unit 22 illustrated in FIG. 26 is an IQ modulator that includes the second branching portion 22A, two child MZMs 22B5, and a single piece of the parent DC phase shifter 22C. The Y polarization modulation unit 23 is an IQ modulator that includes the second branching portion 23A, two child MZMs 23B5, and a single piece of the parent DC phase shifter 23C.

The modulator is connected to the driver circuit 35A that inputs a high frequency signal to each of the RF electrode 34 included in the child MZM 22B5 and the RF electrode 34 included in the child MZM 23B5, and that is formed in a differential drive type for DP-QAM.

In the modulator according to the sixth embodiment, it is possible to implement broadband by allowing the velocity of the signal light propagating through the first LN waveguide 32C1 and the second LN waveguide 32C2 to match by applying the modulator to the MZM with DP-QAM type. In addition, the two optical waveguide arms 32 included in the child MZM 22B5 (23B5) have a folded structure, so that it is possible to reduce the size of the optical transmitter/receiver 1 by downsizing the modulator in the longitudinal direction.

Furthermore, the case has been described as an example in which the two optical waveguide arms 32 included in the child MZM 22B2 (23B2) according to the third embodiment is formed to have a single folded structure to reduce the size of the modulator in the longitudinal direction. However, the example is not limited to this, and an embodiment that implements further reduction in size will be described below as a seventh embodiment. In addition, by assigning the same reference numerals to components having the same configuration as those in the optical transmitter/receiver 1 according to the third embodiment, overlapped descriptions of the configuration and the operation thereof will be omitted.

### (g) Seventh Embodiment

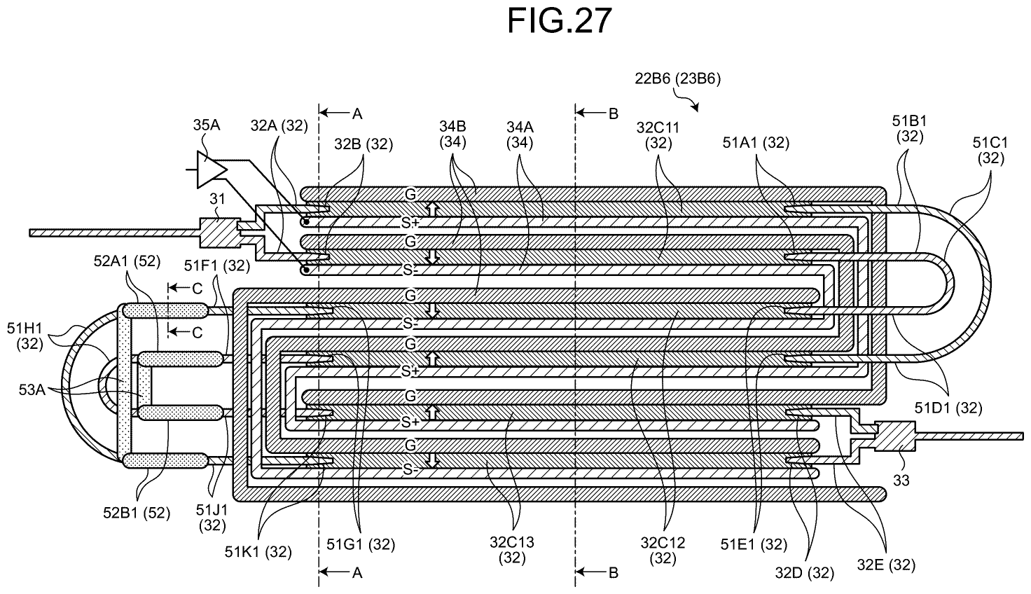

FIG. 27 is a cross-sectional schematic diagram illustrating one example of a child MZM 22B6 (23B6) according to the seventh embodiment. The child MZM 22B2 according to the third embodiment is different from the child MZM 22B6 according to the seventh embodiment in that the two optical waveguide arms 32 are constituted to have a two folded structure.

The two optical waveguide arms 32 include the two first Si waveguides 32A, the two first transition portions 32B, and two first LN waveguides 32C11. The two optical waveguide arms 32 include two third transition portions 51A1, two third Si waveguides 51B1, two folded waveguides 51C1, two fourth Si waveguides 51D1, two fourth transition portions 51E1, and two second LN waveguides 32C12. The two optical waveguide arms 32 include two fifth transition portions 51G1, two fifth Si waveguides 51F1, two folded waveguides 51H1, two sixth Si waveguides 51J1, two sixth transition portions 51K1, and two third LN waveguides 32C13. The two optical waveguide arms 32 include the two second transition portions 32D and the two second Si waveguides 32E.

The first Si waveguide 32A is a Si waveguide with, for example, a channel type. The first Si waveguide 32A is a tapered waveguide in which one end of the waveguide width is formed to have a tapered shape. The first LN waveguide 32C11 is a LN waveguide with, for example, a ridge type. The third Si waveguide 51B1 is a Si waveguide that is formed in, for example, a channel type and that is connected to the folded waveguide 51C1. The third Si waveguide 51B1 is a tapered waveguide in which one end of the waveguide width is formed to have a tapered shape. The folded waveguide 51C1 is a Si waveguide that is formed with a channel type formed to have a U-shaped folded structure with a small bend radius because the third Si waveguide 51B1 strongly confines light.

The fourth Si waveguide 51D1 is a Si waveguide that is formed in, for example, a channel type and that is connected to the folded waveguide 51C1. The fourth Si waveguide 51D1 is a tapered waveguide in which one end of the waveguide width is formed to have a tapered shape. The second LN waveguide 32C12 is a LN waveguide formed in, for example, a ridge type.

The fifth Si waveguide 51F1 is a Si waveguide that is formed in, for example, a channel type and that is connected to the folded waveguide 51H1. The fifth Si waveguide 51F1 is a tapered waveguide in which one end of the waveguide width is formed to have a tapered shape. The folded waveguide 51H1 is a Si waveguide that is formed with a channel type formed to have a U-shaped folded structure with a small bend radius because the fifth Si waveguide 51F1 strongly confines light.

The sixth Si waveguide 51J1 is a Si waveguide that is formed in, for example, a channel type and that is connected to the folded waveguide 51H1. The sixth Si waveguide 51J1 is a tapered waveguide in which one end of the waveguide width is formed to have a tapered shape. The third LN waveguide 32C13 is a LN waveguide formed in, for example, a ridge type. The second Si waveguide 32E is a Si waveguide formed in, for example, a channel type. The second Si waveguide 32E is a tapered waveguide in which one end of the waveguide width is formed to have a tapered shape.

The first transition portion 32B is an interlayer transition portion in which signal light is optically transitioned between the first Si waveguide 32A and the first LN waveguide 32C11 in the respective layers. The RF electrode 34 includes the signal electrodes 34A that are arranged in parallel to the respective waveguides included in the two optical waveguide arms 32, and the ground electrodes 34B that are arranged in parallel to the respective waveguides. In a case where a high frequency signal received from the driver circuit 35A is input, each of the signal electrodes 34A modulates the signal light propagating through the associated first LN waveguide 32C11 that is arranged between the associated ground electrode 34B and the signal electrode 34A.

The third transition portion 51A1 is an interlayer transition portion in which signal light is optically transitioned between the first LN waveguide 32C11 and the third Si waveguide 51B1 in the respective layers. The fourth transition portion 51E1 is an interlayer transition portion in which signal light is optically transitioned between the fourth Si waveguide 51D1 and the second LN waveguide 32C12 in the respective layers. In a case where a high frequency signal received from the driver circuit 35A is input, each of the signal electrodes 34A modulates the signal light propagating through the associated second LN waveguide 32C12 that is arranged between the associated ground electrode 34B and the signal electrode 34A.

The fifth transition portion 51G1 is an interlayer transition portion in which signal light is optically transitioned between the second LN waveguide 32C12 and the fifth Si waveguide 51F1 in the respective layers. The sixth transition portion 51K1 is an interlayer transition portion in which signal light is optically transitioned between the sixth Si waveguide 51J1 and the third LN waveguide 32C13 in the respective layers. In a case where a high frequency signal received from the driver circuit 35A is input, each of the signal electrodes 34A modulates the signal light propagating through the associated third LN waveguide 32C13 that is arranged between the associated ground electrode 34B and the signal electrode 34A.

The second transition portion 32D is an interlayer transition portion in which signal light is optically transitioned between the third LN waveguide 32C13 and the second Si waveguide 32E in the respective layers. The multiplexing portion 33 is a multiplexing portion that is made of, for example, Si, that multiplexes the signal light received from each of the second Si waveguides 32E, and that outputs the multiplexed signal light to the parent DC phase shifter 22C (23C).

The two optical waveguide arms 32 couple a portion between the first LN waveguides 32C11 and the second LN waveguides 32C12 by using the folded waveguides 51C1, respectively, and couple a portion between the second LN waveguides 32C12 and the third LN waveguides 32C13 by using the folded waveguides 51H1, respectively. It is possible to reduce the size of the modulator in the longitudinal direction to ⅓ as compared to the LN waveguide 32C according to the first embodiment.

The child MZM 22B6 includes first heater electrodes 52A1 that are arranged in the respective fifth Si waveguides 51F1, second heater electrodes 52B1 that are arranged in the respective sixth Si waveguide 51J1, and electrode wirings 53A. The electrode wiring 53A is metal wiring that injects an electric current into the first heater electrodes 52A1 and that injects an electric current into the second heater electrodes 52B1.

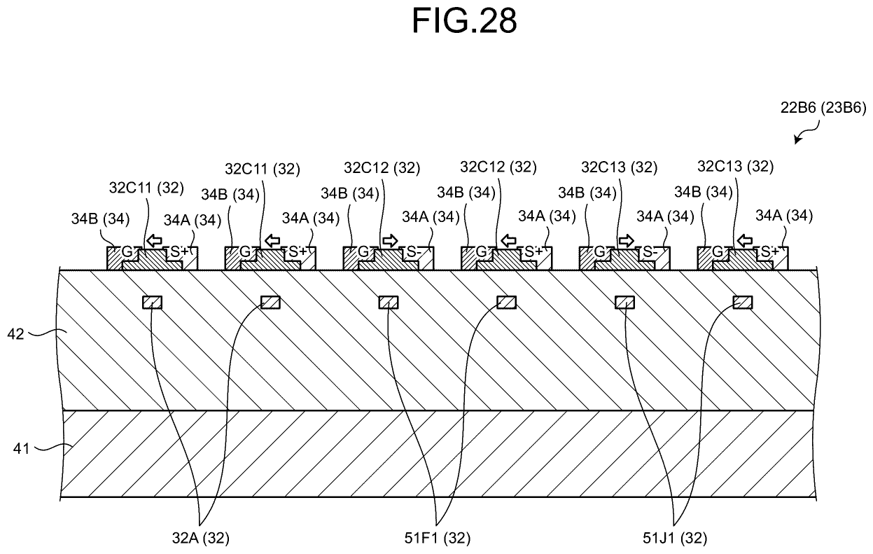

FIG. 28 is a cross-sectional schematic diagram illustrating one example of a cross section taken along line A-A illustrated in FIG. 27. Each of the two optical waveguide arms 32 illustrated in FIG. 28 includes the Si substrate 41, the clad layer 42 that is formed on the Si substrate 41, and the first Si waveguides 32A that are formed in the clad layer 42. Each of the two optical waveguide arms 32 includes the fifth Si waveguides 51F1 that are formed in the clad layer 42, and the sixth Si waveguides 51J1 that are formed in the clad layer 42. The first Si waveguides 32A, the third Si waveguides 51B1, the fourth Si waveguides 51D1, the fifth Si waveguides 51F1, the sixth Si waveguides 51J1, and the second Si waveguides 32E are formed in the same layer.

Each of the two optical waveguide arms 32 includes the first LN waveguide 32C11 that is formed on the clad layer 42, the second LN waveguide 32C12 that is formed on the clad layer 42, and the third LN waveguide 32C13 that is formed on the clad layer 42. Each of the two optical waveguide arms 32 includes the first LN waveguide 32C11, the second LN waveguide 32C12, and the third LN waveguide 32C13 that are arranged in parallel to the RF electrode 34. The first LN waveguide 32C11, the second LN waveguide 32C12, and the third LN waveguide 32C13 are formed in the same layer. Each of the first LN waveguides 32C11 is arranged in parallel between the associated signal electrode 34A and the associated ground electrode 34B. Each of the second LN waveguides 32C12 is arranged in parallel between the associated signal electrode 34A and the associated ground electrode 34B. Each of the third LN waveguides 32C13 is arranged in parallel between the associated signal electrode 34A and the associated ground electrode 34B.

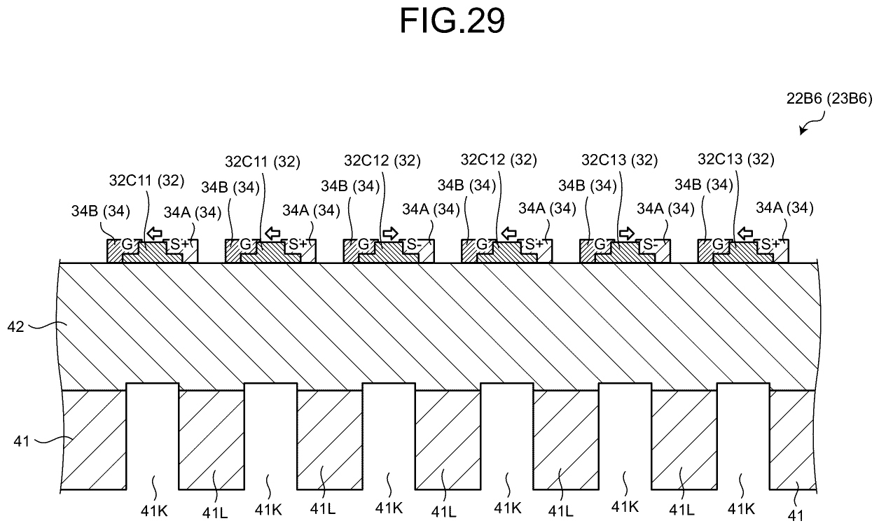

FIG. 29 is a cross-sectional schematic diagram illustrating one example of a cross section taken along line B-B illustrated in FIG. 27. Hollow portions 41K, and residual portions 41L are included in the Si substrate 41 that is located at the lower part of the first LN waveguides 32C11, the second LN waveguides 32C12, and the third LN waveguides 32C13. A plurality of the residual portions 41L are included in the lower part of the first LN waveguides 32C11, the second LN waveguides 32C12, and the third LN waveguides 32C13. Consequently, the first LN waveguides 32C11, the second LN waveguides 32C12, and the third LN waveguides 32C13 are able to ensure high rigidity and strength that are sufficiently able to withstand, for example, a vibration test and an impact test.

The electric permittivity of air in each of the hollow portions 41K is “1”, the electric permittivity of the SiO₂ layer that is the clad layer 42 is about “4”, and the electric permittivity of Si is “12”, so that the electric permittivity of each of the hollow portions 41K and the clad layers 42 is smaller than the electric permittivity of the Si substrate 41. This means that the refractive index of the high frequency signal that a high frequency signal of electricity feels becomes low, and the velocity of a travelling high frequency signal becomes high. Consequently, it is possible to match the velocity of the pieces of signal light propagating through the first LN waveguides 32C11, the second LN waveguides 32C12, and the third LN waveguides 32C13 and the velocity of the high frequency signal.

Each of the signal electrodes 34A includes a first signal electrode that is arranged in the vicinity of the associated first LN waveguide 32C11, a second signal electrode that is arranged in the vicinity of the associated second LN waveguide 32C12, and a third signal electrode that is arranged in the vicinity of the associated third LN waveguide 32C13. Each of the ground electrodes 34B includes a first ground electrode that is arranged in the vicinity of the associated first LN waveguide 32C11, a second ground electrode that is arranged in the vicinity of the associated second LN waveguide 32C12, and a third ground electrode that is arranged in the vicinity of the associated third LN waveguide 32C13. The child MZM 22B6 is connected to the driver circuit 35A that is formed in a differential drive type. The driver circuit is connected to the first signal electrodes, the second signal electrodes, and the third signal electrodes. The driver circuit 35A applies a high frequency signal to the first signal electrodes and the first LN waveguides 32C11 in the same electric field direction, to the second signal electrodes and the second LN waveguides 32C12 in the same electric field direction, and to the third signal electrodes and the third LN waveguides 32C13 in the same electric field direction. Consequently, it is possible to avoid the situation in which phases of modulation are cancelled out.

In the child MZM 22B6, a phase shifter that includes the heater electrode 52 and that compensates a DC drift is arranged. The third phase shifter includes fifth Si waveguides 51F1, and first heater electrodes 52A1 that are formed at the lower part of the respective fifth Si waveguides 51F1. Furthermore, the fourth phase shifter includes sixth Si waveguides 51J1, and s second heater electrodes 52B1 that are formed at the lower part of the respective sixth Si waveguides 51J1.

The third phase shifter heats the first heater electrodes 52A1 by flowing an electric current into the first heater electrodes 52A1, and heats the fifth Si waveguides 51F1 by heat generated by the first heater electrodes 52A1. As a result of the fifth Si waveguides 51F1 being heated, the refractive index of the fifth Si waveguides 51F1 increases, so that the third phase shifter adjusts the phase of the signal light propagating through the fifth Si waveguides 51F1. As a result of the phase of the signal light being adjusted, it is possible to control the operating point voltage by an external auto bias control (ABC) circuit, so that it is possible to compensate a DC drift.

The fourth phase shifter heats the second heater electrodes 52B1 by flowing an electric current into the second heater electrodes 52B1, and heats the sixth Si waveguides 51J1 by heat generated by the second heater electrodes 52B1. As a result of the sixth Si waveguides 51J1 being heated, the refractive index of the sixth Si waveguides 51J1 increases, so that the fourth phase shifter adjusts the phase of the signal light propagating through the sixth Si waveguides 51J1. As a result of the phase of the signal light being adjusted, it is possible to control the operating point voltage by an external auto bias control (ABC) circuit, so that it is possible to compensate a DC drift.

The two optical waveguide arms 32 according to the seventh embodiment couple a portion between the first LN waveguides 32C11 and the second LN waveguides 32C12 by using the folded waveguides 51C1, respectively, and couple a portion between the second LN waveguides 32C12 and the third LN waveguides 32C13 by using the folded waveguides 51H1, respectively. Consequently, it is possible to reduce the size of the modulator in the longitudinal direction to ⅓ as compared to the LN waveguide 32C according to the first embodiment.

### (h) Eighth Embodiment

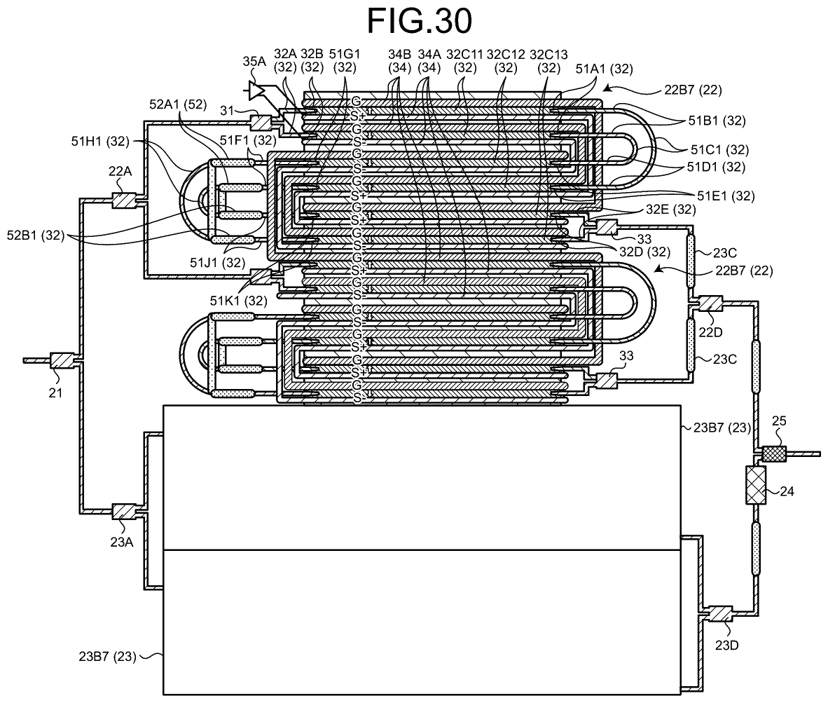

FIG. 30 is a schematic plan diagram illustrating one example of a modulator according to an eighth embodiment. The modulator includes the X polarization modulation unit 22 that is constituted by two single type MZMs operating at a baud rate of 200 G, and the Y polarization modulation unit 23 that is constituted by two single type MZMs. The modulator according to the sixth embodiment is different from the modulator according to the eighth embodiment in that a MZM with a type of dual polarization-quadrature phase shift keying (DP-QPSK) is arranged instead of the MZM with a type of DP-QAM.

The X polarization modulation unit 22 illustrated in FIG. 30 is one of the IQ modulators that includes the second branching portion 22A, two child MZMs 22B7, and a single piece of the parent DC phase shifter 22C. The Y polarization modulation unit 23 is the other of the IQ modulators that includes the second branching portion 23A, two child MZMs 23B7, and a single piece of the parent DC phase shifter 23C.

The modulator is connected to the driver circuit 35A that is formed in a differential drive type used for DP-QPSK and that inputs a high frequency signal to both of the RF electrode 34 included in the child MZMs 22B7 and the RF electrode 34 included in the child MZMs 23B7.

In the modulator according to the eighth embodiment, it is possible to implement wideband by allowing the velocity of the signal light propagating through the first LN waveguides 32C11, the second LN waveguides 32C12, and the third LN waveguides 32C13 to match by applying the modulator to the MZM with DP-QPSK type. In addition, the two optical waveguide arms 32 included in the child MZM 22B7 (23B7) have the folded structure, so that it is possible to reduce the size of the optical transmitter/receiver 1 by downsizing the modulator in the longitudinal direction.

The case has been described as an example in which LN (LiNbO₃) is used as an electro-optical material of the optical modulator element 2. For example, a perovskite-type oxide material may also be used, and appropriate modifications are possible. Examples of the perovskite-type oxide material used include (Pb) (Zr, Ti) O₃ (hereinafter, denoted by PZT), (Pb, La) (Zr, Ti) O₃, (hereinafter, denoted by, PLZT), BaTiO₃ (hereinafter, denoted by BTO), (Sr, Ba) TiO₃ (hereinafter, denoted by SBT), and LiNbO₃ (hereinafter, denoted by LN). However, a perovskite-type oxide material having another electro-optical effect may be used.

Furthermore, in the present embodiment, the case has been described as an example in which the LN waveguide 32C is used, but any material may be used as long as a material that has the electric permittivity lower than that of Si and that also has electro-optical effect higher than that of Si is used, and appropriate modifications are possible.

### (i) Ninth Embodiment

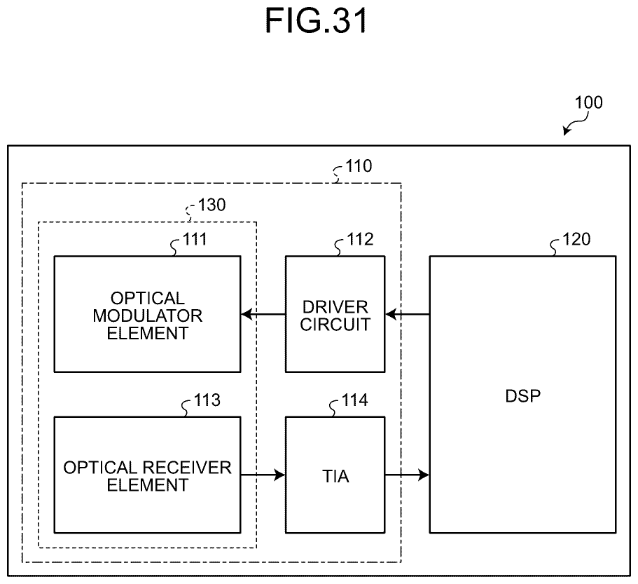

In the following, an optical transceiver 100 that uses the optical transmitter/receiver 1 according to the present embodiment will be described. FIG. 31 is a block diagram illustrating one example of the optical transceiver 100 according to the present embodiment. The optical transceiver 100 illustrated in FIG. 31 includes an optical transmitter/receiver 110, and a digital signal processor (DSP) 120. The optical transmitter/receiver 110 includes an optical modulator element 111 in an optical module 130, a driver circuit 112, an optical receiver element 113 in the optical module 130, and a transimpedance amplifier (TIA) 114. The DSP 120 performs overall control of the optical transmitter/receiver 110. The DSP 120 is an electrical component that performs an IQ modulation process on a transmission signal and a demodulation process on a reception signal, and that performs digital signal processing.

The DSP 120 performs a process of, for example, encoding transmission data or the like, generating an electrical signal including the transmission data, and then, outputs the generated electrical signal to the driver circuit 112. The driver circuit 112 drives the optical modulator element 111 in accordance with the electrical signal received from the DSP 120. The optical modulator element 111 optically modulates the signal light. The optical modulator element 111 is the optical modulator element described above in the first to the eighth embodiments.

The optical receiver element 113 performs electrical conversion on the signal light. The TIA 114 amplifies the electrical signal that has been subjected to the electrical conversion, and outputs the amplified electrical signal to the DSP 120. The DSP 120 obtains reception data by performing a process of decoding or the like on the electrical signal acquired from the TIA 114. The optical transmitter/receiver 1 is constituted by both of the optical modulator element 111 and the optical receiver element 113. However, the embodiment is not limited to the optical transmitter/receiver 1, an optical transmitter that includes only the optical modulator element 111 as a built-in unit may also be applicable.

According to an aspect of one embodiment, a wider bandwidth of a modulator is implemented by ensuring a velocity matching between an electrical signal and signal light.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical modulator element comprising:
an optical branching portion and an optical multiplexing portion each of which includes a first material and is formed on a substrate;
two optical waveguide arms each of which connects the optical branching portion and the optical multiplexing portion and is formed on the substrate; and
electrodes that apply an electrical signal to the two optical waveguide arms and that are formed on the substrate, wherein
each of optical waveguides of the two optical waveguide arms includes
a first optical waveguide that includes the first material,
a second optical waveguide that includes a second material that has a higher electro-optical effect than the first material, and
a transition portion that performs an optical transition between the first optical waveguide and the second optical waveguide, and
the substrate includes a hollow portion in which all or a part of the substrate located below the second optical waveguide in a plan view has been removed.

2. The optical modulator element according to claim 1, wherein the electrodes are capacity loading type electrodes.

3. The optical modulator element according to claim 1, wherein the first material includes Si, and the second material includes LiNbO₃.

4. The optical modulator element according to claim 1, wherein the hollow portion is a hollow portion that is formed by removing all or a part of the substrate located below the two optical waveguide arms.

5. The optical modulator element according to claim 1, wherein
the substrate that is located at a lower part of the second optical waveguide includes
the hollow portion, and
a residual portion that is other than the hollow portion, and
a proportion of the hollow portion occupying in an area of the substrate that is located at the lower part of the second optical waveguide is within 40% to 80%.

6. The optical modulator element according to claim 1, wherein an opening width of the hollow portion is within at least a range of 3 μm to 12 μm.

7. The optical modulator element according to claim 6, wherein the opening width of the hollow portion is within a range of 5 μm to 10 μm included in the range of 3 μm to 12 μm.

8. The optical modulator element according to claim 1, wherein
the second optical waveguide includes
a first straight line waveguide,
a second straight line waveguide, and
a folded waveguide that connects the first straight line waveguide and the second straight line waveguide, and
the folded waveguide includes the first material.

9. The optical modulator element according to claim 8, wherein
the folded waveguide
includes a heater electrode that is arranged in the vicinity of the folded waveguide and that heats the folded waveguide, and
adjusts a phase of signal light propagating through the folded waveguide in accordance with injection of an electric current into the heater electrode.

10. The optical modulator element according to claim 1, further including a clad layer that is formed on the substrate, wherein the optical modulator element includes
the first optical waveguide that is formed in the clad layer,
the second optical waveguide that is formed on the clad layer, and
the electrodes that are formed on the clad layer, wherein the optical modulator element further includes a via that passes through front and back sides of both of the substrate and the clad layer, and that is electrically connected to the electrodes.

11. The optical modulator element according to claim 1, further including a clad layer that is formed on the substrate, wherein the optical modulator element includes
the first optical waveguide that is formed in the clad layer,
the second optical waveguide that is formed in the hollow portion included in the clad layer, and
the electrodes that are formed in the hollow portion included in the clad layer, wherein the optical modulator element further includes a via that passes through front and back sides of both of the substrate and the clad layer, and that is electrically connected to the electrodes.

12. The optical modulator element according to claim 1, wherein
the second optical waveguide includes
a first straight line waveguide,
a second straight line waveguide,
a third straight line waveguide,
a first folded waveguide that connects the first straight line waveguide and the second straight line waveguide, and
a second folded waveguide that connects the second straight line waveguide and the third straight line waveguide, and
each of the first folded waveguide and the second folded waveguide includes the first material.

13. An optical transmitter comprising an optical modulator element that includes, on a substrate, an optical branching portion and an optical multiplexing portion each of which includes a first material, two optical waveguide arms each of which connects the optical branching portion and the optical multiplexing portion, and electrodes that apply an electrical signal to the two optical waveguide arms, wherein
each of optical waveguides of the two optical waveguide arms includes
a first optical waveguide that includes the first material,
a second optical waveguide that includes a second material that has a higher electro-optical effect than the first material, and
a transition portion that performs an optical transition between the first optical waveguide and the second optical waveguide, and
the substrate includes a hollow portion in which all or a part of the substrate located below the second optical waveguide in a plan view has been removed.

14. An optical transceiver comprising:
an optical modulator element that includes an optical modulator;
an optical receiver element that includes an optical receiver; and
a processor that executes signal processing on the optical modulator and the optical receiver, wherein
the optical modulator element includes, on a substrate,
an optical branching portion and an optical multiplexing portion each of which includes a first material,
two optical waveguide arms each of which connects the optical branching portion and the optical multiplexing portion, and
electrodes that apply an electrical signal to the two optical waveguide arms,
each of optical waveguides of the two optical waveguide arms includes
a first optical waveguide that includes the first material,
a second optical waveguide that includes a second material that has a higher electro-optical effect than the first material, and
a transition portion that performs an optical transition between the first optical waveguide and the second optical waveguide, and
the substrate includes a hollow portion in which all or a part of the substrate located below the second optical waveguide in a plan view has been removed.
